(19) United States
(12) Patent Application Publication
(10) Pub. No.: US 2026/0099947 A1
(43) Pub. Date: Apr. 9, 2026

(54) MONITORING SENSOR FUNCTIONALITY FOR AUTONOMOUS AND SEMI-AUTONOMOUS SYSTEMS AND APPLICATIONS

(71) Applicant: NVIDIA Corporation, Santa Clara, CA (US)

(72) Inventors: Wangren Xu, San Jose, CA (US); Robin Brian Jenkin, Morgan Hill, CA (US); Douglas John Taylor, San Diego, CA (US)

(21) Appl. No.: 18/908,175

(22) Filed: Oct. 7, 2024

(51) Int. Cl. G06T 7/80; G06T 5/60; G06V 10/70; G06V 20/56

(52) U.S. Cl. CPC G06T 7/80; G06T 5/60; G06V 10/70; G06V 20/56; G06T 2207/20081

(57) ABSTRACT

In various examples, sensors that are deployed or otherwise in-service may be continuously monitored over time using sensor data generated by the sensors. For instance, the disclosed systems and methods may obtain sensor data representing an image of an object and compare the image to a reference image of the same object. In some examples, the image and/or the reference image may be modified for the comparison such that spatial characteristics of the object are similar in both the image and the reference image. Based at least on differences between the compared images, metrics indicating an image quality associated with the image may be computed, and the performance of the sensor that generated the sensor data may be determined. Additionally, in some instances, the one or more parameters associated with the sensor may be updated based on the image quality and/or the performance of the sensor.

### BACKGROUND

Autonomous or semi-autonomous vehicles or machines may include various sensors—such as image sensors, LiDAR sensors, RADAR sensors, and/or other sensors—that can be used to enable various functionalities, including, but not limited to, navigation, path planning, obstacle detection, and environment perception and recognition. For instance, the sensors may generate sensor data—such as image data, LiDAR data, RADAR data, and/or other data—associated with an environment in which a machine is operating, and various systems of the machine may process the sensor data to generate an understanding of the environment and determine operations for the machine to perform. However, variations in sensor quality across different units, as well as aging of the sensors themselves, can lead to significant challenges in deploying sensors at scale.

For example, Image Signal Processor (ISP) settings and/or other parameters may be derived from a benchmark or “golden” camera module and then generically applied to multiple different image sensors (e.g., cameras) across a fleet of autonomous systems. However, due to process variations in lens manufacturing, sensors, micro-lenses, color filter arrays, and/or other image sensor components, applying generic ISP setting parameters in a blanket manner to multiple image sensors may result in various inconsistencies in image quality, including, but not limited to, differences in sharpness, contrast, tone reproduction, noise levels, and color accuracy. Thus, despite intentions for uniformity and optimization, differences between individual image sensors may result in noticeable disparities in image quality when generic settings are used.

Additionally, traditional approaches for measuring image quality may be conducted only once during image sensor production. However, image sensors may frequently experience a decline in image quality over time, which may be due to a variety of factors associated with aging and continued use. For instance, anti-reflective coatings on lens elements may experience degradation due to exposure to environmental factors—such as ultraviolet (UV) light, humidity, abrasion from dust and chemicals, etc.—leading to increased flare, ghosting, decreased contrast, among other undesirable optical effects. As another example, repeated exposure to extreme temperature changes may gradually affect the physical alignment of lens elements as different materials in the lens expand and/or contract at different rates.

### SUMMARY

Embodiments of the present disclosure relate to monitoring sensor functionality for autonomous or semi-autonomous systems and applications. For instance, systems and methods described herein may use sensor data to continuously (and/or at given time intervals) monitor the performance of sensors that are deployed or otherwise in-service. In some examples, the disclosed systems and methods may obtain sensor data representing an image of an object and compare the image to a reference image of the same object. As described herein, the image and/or the reference image may, in some instances, be modified for the comparison such that spatial characteristics of the object are similar or the same in both the image and the reference image. Based at least on differences between the compared images, metrics indicating an image quality associated with the image may be computed, and the performance of the sensor that generated the sensor data may be evaluated. Additionally, in some instances, the one or more parameters associated with the sensor may be updated based on the image quality and/or the performance of the sensor.

In contrast to conventional systems, the systems of the present disclosure, in some embodiments, are able to monitor the performance—or degradation in performance—of deployed or otherwise in-service image sensors by continuously evaluating image quality factors (e.g., Spatial Frequency Response (SFR), tone reproduction, noise levels, and color accuracy, etc.) associated with image data generated using the image sensors. For example, by comparing images of known objects with synthetically produced models of the known objects, the systems may analyze any differences and compute image quality measures and/or other metrics to evaluate sensor performance. Additionally, in contrast to conventional systems, the systems of the present disclosure may then, in some embodiments, initiate one or more corrective actions responsive to determining that an image sensor and/or the quality of images generated by the image sensor have degraded (e.g., by more than a threshold). For instance, the systems of the present disclosure may initiate a reconfiguration of the ISP, cause a replacement and/or servicing of the image sensor, or initiate performance of any other remedial measures associated with the image sensor.

### BRIEF DESCRIPTION OF THE DRAWINGS

The present systems and methods for monitoring sensor functionality for autonomous or semi-autonomous systems and applications are described in detail below with reference to the attached drawing figures, wherein:

FIG. 1 illustrates an example data flow diagram for a process of monitoring sensor functionality, in accordance with some embodiments of the present disclosure;

FIG. 2 illustrates an example of an environment that includes an object capable of being used to monitor sensor performance, in accordance with some embodiments of the present disclosure;

FIG. 3 illustrates an example of modifying a captured image of the object depicted in the example of FIG. 2, in accordance with some embodiments of the present disclosure;

FIG. 4 illustrates an example of modifying a reference image of a reference object that corresponds to the object depicted in the example of FIG. 2, in accordance with some embodiments of the present disclosure;

FIG. 5 is a data flow diagram illustrating an example process for training one or more machine learning models to perform one or more operations associated with monitoring sensor performance, in accordance with some embodiments of the present disclosure;

FIG. 6 illustrates an example of a system that may perform one or more of the processes described herein, in accordance with some embodiments of the present disclosure;

FIG. 7 is a flow diagram illustrating an example method associated with monitoring sensor performance over time and updating sensor parameters to improve sensor performance, in accordance with some embodiments of the present disclosure;

FIG. 8 is a flow diagram illustrating an example method for comparing images of objects with reference images of object to monitor sensor functionality, in accordance with some embodiments of the present disclosure;

FIG. 9A is an illustration of an example autonomous vehicle, in accordance with some embodiments of the present disclosure;

FIG. 9B is an example of camera locations and fields of view for the example autonomous vehicle of FIG. 9A, in accordance with some embodiments of the present disclosure;

FIG. 9C is a block diagram of an example system architecture for the example autonomous vehicle of FIG. 9A, in accordance with some embodiments of the present disclosure;

FIG. 9D is a system diagram for communication between cloud-based server(s) and the example autonomous vehicle of FIG. 9A, in accordance with some embodiments of the present disclosure;

FIG. 10 is a block diagram of an example computing device suitable for use in implementing some embodiments of the present disclosure; and

FIG. 11 is a block diagram of an example data center suitable for use in implementing some embodiments of the present disclosure.

### DETAILED DESCRIPTION

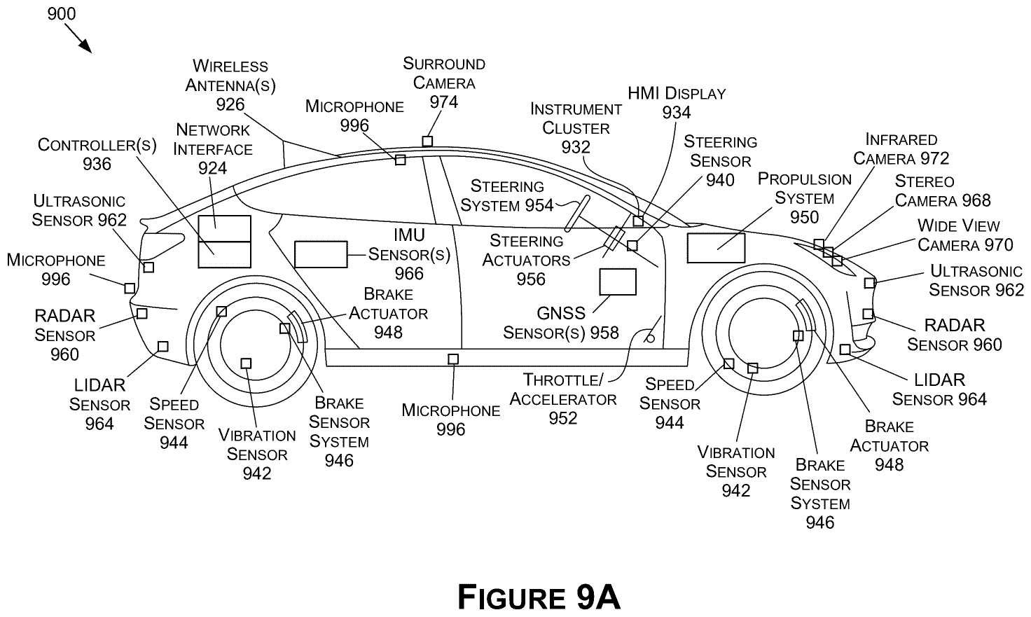

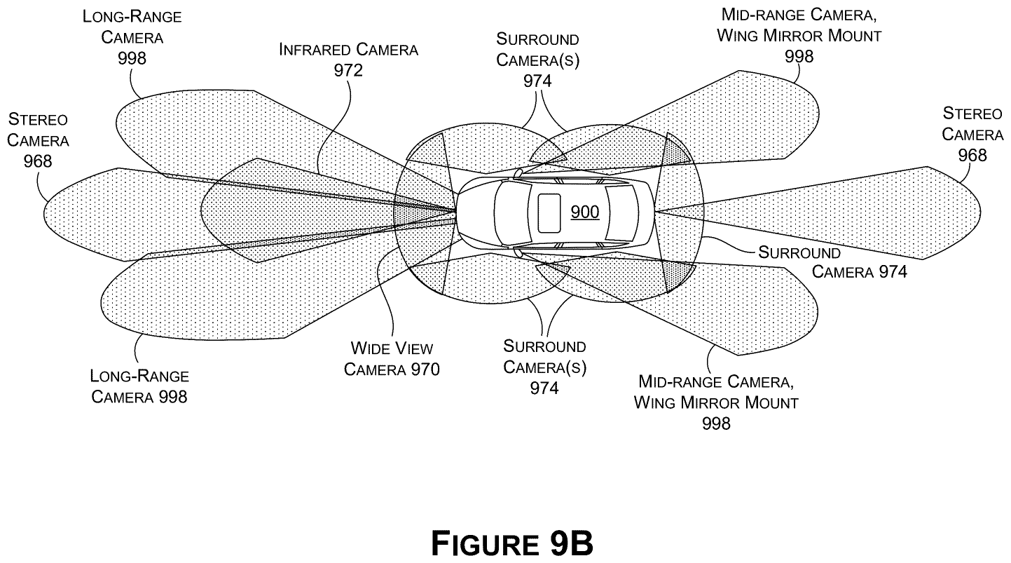

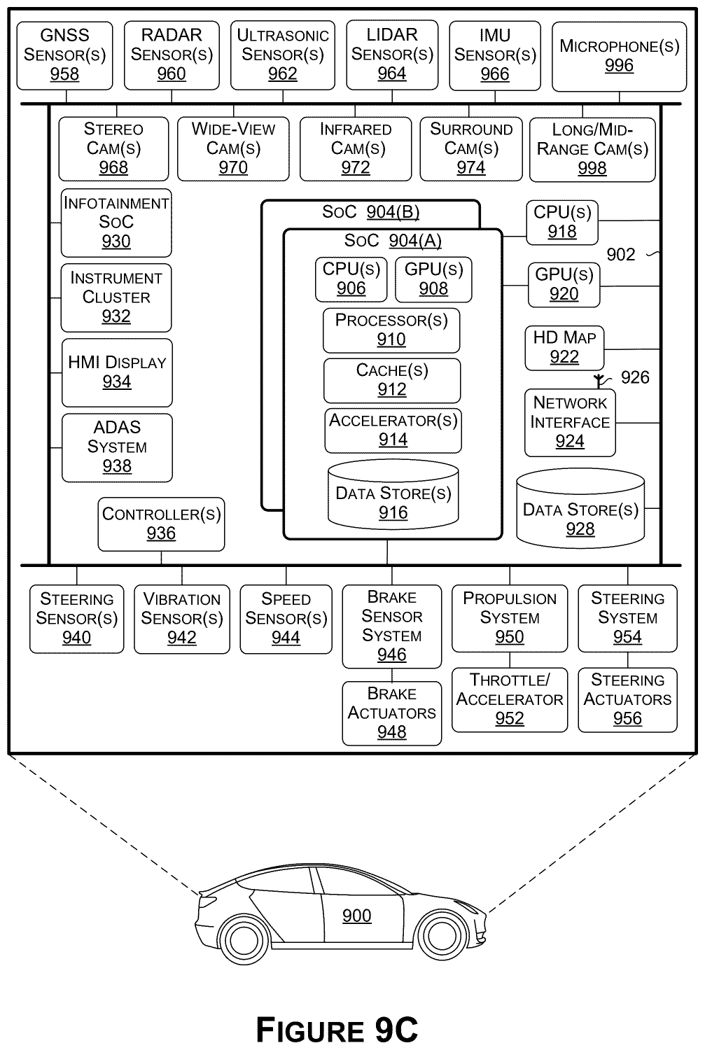

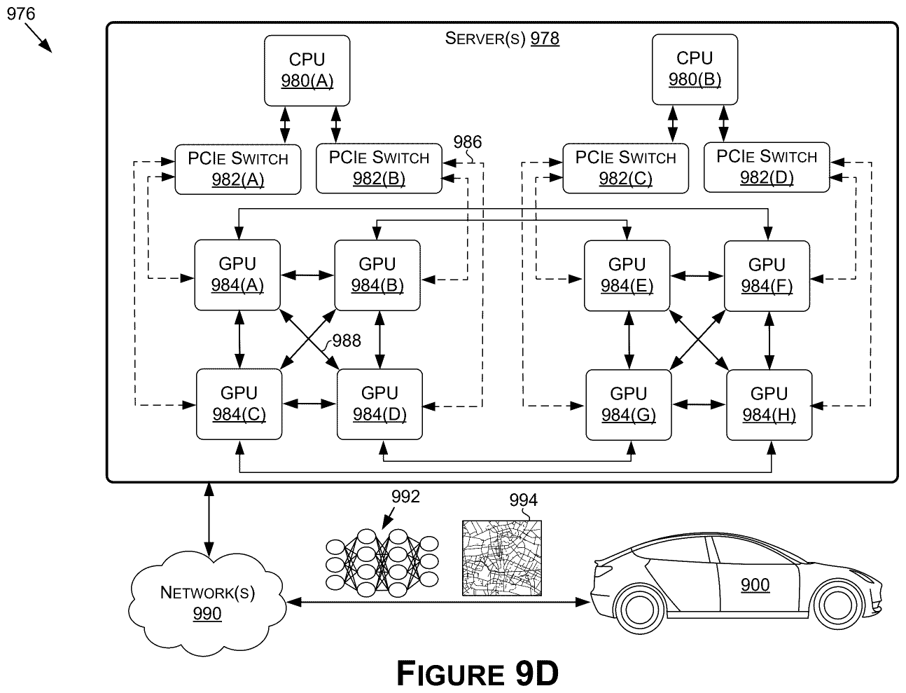

Systems and methods are disclosed related to monitoring sensor functionality for autonomous or semi-autonomous systems and applications. Although the present disclosure may be described with respect to an example autonomous or semi-autonomous vehicle or machine 900 (alternatively referred to herein as “vehicle 900,” “ego-vehicle 900,” “ego-machine 900,” or “machine 900,” an example of which is described with respect to FIGS. 9A-9D), this is not intended to be limiting. For example, the systems and methods described herein may be used by, without limitation, non-autonomous vehicles or machines, semi-autonomous vehicles or machines (e.g., in one or more adaptive driver assistance systems (ADAS)), piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, underwater craft, drones, and/or other vehicle types. In addition, although the present disclosure may be described with respect to sensors for autonomous vehicles or machines, this is not intended to be limiting, and the systems and methods described herein may be used in augmented reality, virtual reality, mixed reality, robotics, security and surveillance, autonomous or semi-autonomous machine applications, and/or any other technology spaces where sensor performance monitoring may be used.

For instance, a system(s) may obtain sensor data from one or more sensors of a machine operating in an environment. In some examples, the sensor data may include image data generated using one or more image sensors (e.g., cameras), LiDAR data generated using one or more LiDAR sensors, RADAR data generated using one or more RADAR sensors, or any other type of sensor data generated using any other type of sensor. For instance, while many of the examples in the present disclosure are with respect to image data and image sensors, this is not intended to be limiting, and in additional or alternative examples any type of sensor data may be used to monitor the performance of any type of sensor.

In the case of image data, the image data may represent an image (also referred to herein as a “captured image”) of an object in the environment, and the system(s) may compare the image to an ideal, reference image of the same or similar object (also referred to herein as a “reference object”) to evaluate the performance of the image sensor used to generate the image data. As described herein, in some instances the image and/or the reference image may be modified for the comparison such that spatial characteristics of the object are similar or the same in both the image and the reference image. Based at least on differences between the compared images, the system(s) may compute one or more metrics indicating an image quality associated with the image, and the system(s) may evaluate the performance of the image sensor using the metric(s). Additionally, in some instances, the system(s) may update one or more parameters associated with the image sensor based on the image quality and/or the performance of the image sensor to, e.g., improve the performance of the image sensor.

In some examples, the system(s) may use various object detection and/or semantic segmentation techniques to identify objects (also referred to as “target objects” or “known objects”) or regions depicted in the captured images. The target or known objects may be objects for which the system(s) maintains one or more reference objects/images. As described herein, in some instances the target objects may include traffic signs, such as stop signs, speed limit signs, yield signs, crosswalk signs, or any other road signs or road markings, and the system(s) may store one or more reference images depicting these objects. However, these are just some examples, and in additional or alternative embodiments the target objects may include any other type of object for which a reference object/image is maintained. In some examples, the reference images may be obtained from a library or database of high resolution or vector graphic images of the traffic signs, road markings, objects, or textures. Additionally, or alternatively, the reference images may be synthetically generated, rendered, or derived from high-resolution ideal image captures.

In some examples, the system(s) may use one or more object detection models to detect, localize, and/or segment the target objects depicted in the captured images, as well as to provide information regarding the target object's shape, orientation, position, angle, geometry, or any other spatial characteristics. For instance, the system(s) may apply one or more captured images to the object detection models, and the object detection models may process the captured images and determine, among other things, that the captured images include target objects (e.g., stop signs, yield signs, etc.), identities of the target objects, where the target objects are located, the orientation or geometries of the target objects, and/or any other information associated with the target objects and/or the captured images. The object detection models may include, in some instances, one or more machine learning models (e.g., one or more deep neural networks (DNNs), one or more convolutional neural networks (CNNs), etc.), one or more computer-vision algorithms, one or more traditional algorithmic processes, or any other type of models.

In some instances, for the system(s) to perform comparisons between the captured images and the reference images, the system(s) may update or modify at least one of the images. For instance, if spatial characteristics associated with the object in the captured image differ by more than a threshold from those of the reference object in the reference image, the system(s) may update (e.g., modify, transform, skew, warp, etc.) the captured image and/or the reference image to align the objects depicted in the images. That is, the system(s) may estimate spatial features (e.g., shape, orientation, angle, and/or geometry) of the target object in the captured image and use the estimation to determine a spatial transform to update the captured image or the reference image such that the spatial features of the object and the reference objects correspond with one another. As an example, if the captured image of the object depicts the object as being viewed from an angled perspective (e.g., 10-degrees, 20-degrees, etc.) and the reference image depicts the reference object as being viewed straight on (e.g., 0-degrees), the system(s) may modify the captured image or the reference image so that both objects are depicted from the same perspective and have the same or similar geometric and/or spatial features (e.g., both objects appear the same in both images, either straight on or angled).

In at least one example, the system(s) may use deep learning algorithms/models—such as homography learning with deep learning, unsupervised learning, reinforced learning, etc. —or computer vision algorithms to identify features, match features, compute homography, and update the captured images of the objects to match the reference images of the reference objects in terms of shape, orientation, position, angle, geometry, etc. For instance, the system(s) may use traditional computer vision algorithms (e.g., Scale-Invariant Feature Transform (SIFT), Oriented FAST and Rotated BRIEF (ORB), etc.) to identify key points (or features) in both the captured images and the reference images by applying a feature detector to both images to find the key points, which may correspond to corners, edges, or blobs in the images.

In some examples, the system(s) may compute a descriptor for each key point of the captured images and the reference images. The descriptors may encode the appearance of the key point's neighborhood and allow for comparing key points robustly. The system(s) may then, in some instances, compare the descriptors between the two sets of key points (e.g., the key points from the captured image and the key points form the reference image) to find matches. In some examples, the system(s) may use a distance measure like Euclidean distance for SIFT or Hamming distance for ORB. Additionally, the system(s) may employ strategies such as Nearest Neighbors or the Lowe's ratio test to filter strong matches. In some instances, once a set of matched key points is determined between a pair of images (e.g., a captured image and a reference image), the system(s) may compute a homography matrix using various algorithms, such as Random Sample Consensus (RANSAC). These algorithms may help the system(s) identify and filter out outlier matches that do not fit the model well.

In at least one example, to modify the captured images or the reference images to correspond to one another, the system(s) may use the homography matrix to transform one or more coordinates of the captured image to a coordinate system associated with the reference image, or vice-versa. In some instances, to update the captured image (or the reference image) the system(s) may interpolate pixel values to account for non-integer coordinates in the transformed space. For instance, the system(s) may use bilinear or bicubic interpolation to interpolate the pixel values.

In some examples, the system(s) may train a neural network (or other type of machine learning model) to predict the homography matrix directly from pairs of images to use homography learning with deep learning. For instance, the system(s) may train a convolutional neural network (CNN) (and/or another type of DNN) that takes a pair of images (e.g., captured image of target object and reference image of the same target object) as inputs and then outputs the parameters of the homography matrix. The CNN may be trained by the system(s) to extract relevant features and understand the spatial relationships between the two images. For instance, the system(s) may train the CNN using a training dataset of image pairs with known homographies, and a loss function may be designed to minimize the difference between the predicted homography and the ground-truth homography.

In some examples, the system(s) may use unsupervised learning to learn feature representations without explicitly labeled data. For example, the system(s) may use autoencoders to learn efficient representations of images that highlight their distinctive features, facilitating better matching between images. Generative Adversarial Networks (GANs) may be used to generate synthetic image pairs with known transformations, including homographies, which may then be used to train a model in a supervised manner without manually labeled data.

As described herein, once the spatial and/or geometric characteristics of the captured image/object correspond to the reference image/object in terms of shape, orientation, position, angle, geometry, etc., the system(s) may compare the images to compute various image quality metrics. In some examples, the image quality metrics may include, but may not be limited to, point spread function (PSF) values, modulation transfer function (MTF) values, noise equivalent quanta (NEQ) values, edge spread function values (e.g., edge transfer curve (ETC) values), Delta E quality (Delta E) values, tone reproduction values, contrast values, color fidelity/error values, lighting values, noise values, Detective Quantum Efficiency (DQE) values, Noise Power Spectrum (NPS) values, information capacity values, separation of target to background values, dynamic range values, Signal-to-Noise Ratio (SNR) values, Ideal Observer SNR (SNRI) values, separation of target to background values, color separability or color separation probability values, chroma artifacts values, “ghosts” values, aliasing values, ringing values, and chromatic aberration values. The system(s) may, in some instances, feed the metrics back to an image signal processor (ISP) associated with the image sensor to optimize tuning parameters (e.g., sharpening, color correction matrix (CCM), noise reduction, tone mapping, gamma, white balance, etc.) and improve image quality of the image sensor that captured the image of the target object.

In some instances, the system(s) may backward project the object depicted in the captured image back to a common three-dimensional (3D) coordinate system that is shared between image sensors, LiDAR sensors, RADAR sensors, etc. to obtain depth and velocity information associated with the target object. By backward projecting the object and obtaining the depth and velocity information, the system(s) may be able to associate the calculated MTF and/or PSF with depth since MTF and PSF vary with depth. In various examples, as the machine moves closer to the target object (e.g., moves toward a traffic sign from a distance), the system(s) may calculate the MTF and/or PSF at each depth as the machine approaches the target object.

In some instances, if the object detection model (e.g., DNN, CNN, computer vision, etc.) is unable to classify the target object from a long distance, the system(s) may retroactively apply the proposed image quality measurement to the remote target object once the machine has approached close enough for successful object classification, with the help of the existing moving trajectory of the object provided by the autonomous driving system. In some examples, the system(s) may use velocity information provided by RADAR and/or other sensors to emulate motion blur, which may make the reference images of the target object correspond more closely to the captured image of the target object, improving the accuracy of the image quality measurements or other metrics.

Additionally, in some examples, the system(s) of the present disclosure may identify non-idealities or imperfections associated with target objects. For instance, and for target objects that include traffic signs, the system(s) may identify paint deterioration, bent sheet metal (of the sign), bent signposts, vandalism/graffiti, concealment by vegetation, adhered substances, dirt substances, dents, etc. As a fleet of autonomous machines may constantly use image sensors to generate images of the same target objects in an environment from various angles, distances, speeds, etc., the system(s) may update the reference images for those target objects through comparisons between captured images of the target objects over time. Additionally, the system(s) may update the reference images or otherwise introduce these imperfections to the reference images for those target objects, minimizing the impact of the imperfections/non-idealities when computing image quality metrics associated with an image sensor.

In some examples, the system(s) may store one or more of the captured images in a memory for processing offline when the machine is not in use. For example, the system(s) may store captured images that depict a large number of target objects for offline processing. In this way, computation cycles may be allocated for drive calculations and/or other autonomous or semi-autonomous operations, instead of being consumed to update image quality measures. Instead, computation may be performed when the machine is parked, in a charge mode, or otherwise inactive. The image quality measures may also be categorized against prevailing environmental conditions such as light levels, times of day, temperatures, and/or any other information available at the time of capture of the images.

In some embodiments, the systems and methods described herein may be performed within a simulation environment (e.g., NVIDIA's DriveSIM) using simulated data (e.g., simulated sensor data of simulated sensors of a virtual or simulated machine). For example, simulated sensor data may be used (e.g., processed using one or more machine learning models, neural networks, etc.) to evaluate the performance or accuracy of sensor degradation algorithms or processes, etc. within the simulation environment. These simulated operations may be used to test performance of the underlying algorithms, systems, and/or processes prior to deploying them in the real-world. In some instances, the simulation may be used to generate synthetic training data—e.g., training data including regions of interest and/or sub-regions of interest from within the simulation. In some embodiments, other methods may be used in addition or alternatively from a simulation to generate synthetic training data. For example, the synthetic training data may be generated using neural rendering fields (NERFs), Gaussian splat techniques, diffusion models, electrostatic models (e.g., Poisson flow generative models (PFGMs), etc. The synthetic training data (in addition to or alternatively from real-world data) may then be processed to determine information pertaining to virtual sensors of a virtual machine, for example. In any example, such as where a simulation environment is used for testing, validation, training, etc., the simulation environment and/or associated training data may be rendered or otherwise generated using one or more light transport algorithms—such as ray-tracing and/or path-tracing algorithms. In some embodiments, the simulation environment and/or one or more objects, features, or components thereof may be generated or managed within a three-dimensional (3D) content collaboration platform (e.g., NVIDIA's OMNIVERSE) for industrial digitalization, generative physical AI, and/or other use cases, applications, or services. For example, the content collaboration platform or system may include a system that uses universal scene descriptor (USD) (e.g., OpenUSD) data for managing objects, features, scenes, etc. within a simulated environment, digital environment, etc. The platform may include real physics simulation, such as using NVIDIA's PhysX SDK, in order to simulate real physics and physical interactions with simulations hosted by the platform. The platform may integrate OpenUSD along with ray tracing/path tracing/light transport simulation (e.g., NVIDIA's RTX rendering technologies) into software tools and simulation workflows for building, training, deploying, or testing AI systems—such as systems for testing, validating, training (e.g., machine learning models, neural networks, etc.), and/or other tasks related to automotive, robot, machine, or other applications.

In some embodiments, teleoperation or remote control of a vehicle or other machine may be performed using a remote control or teleoperation system. For example, the systems and methods described herein may be used to provide performance or degradation information related to sensors of the machine to a remote operator so that the remote operator may account for or perform operations corresponding to, for example, areas of the environment where perception may be lacking due to sensor performance issues. For example, a visualization provided to a remote operator may indicate which sensors and/or portions of an environment are not well perceived by the machine, and the remote operator may use this information when controlling—or providing waypoints or other indications of control or navigation—an autonomous or semi-autonomous machine through an environment.

The systems and methods described herein may be used by, without limitation, non-autonomous vehicles or machines, semi-autonomous vehicles or machines (e.g., in one or more adaptive driver assistance systems (ADAS)), autonomous vehicles or machines, piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, underwater craft, drones, and/or other vehicle types. Further, the systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems implementing language models, such as large language models (LLMs), vision language models (VLMs), and/or multi-modal language models, systems incorporating one or more virtual machines (VMs), systems for performing synthetic data generation operations, systems implemented at least partially in a data center, systems for performing conversational AI operations, systems for performing light transport simulation, systems for performing collaborative content creation for 3D assets, systems for performing generative AI operations, systems implemented at least partially using cloud computing resources, and/or other types of systems.

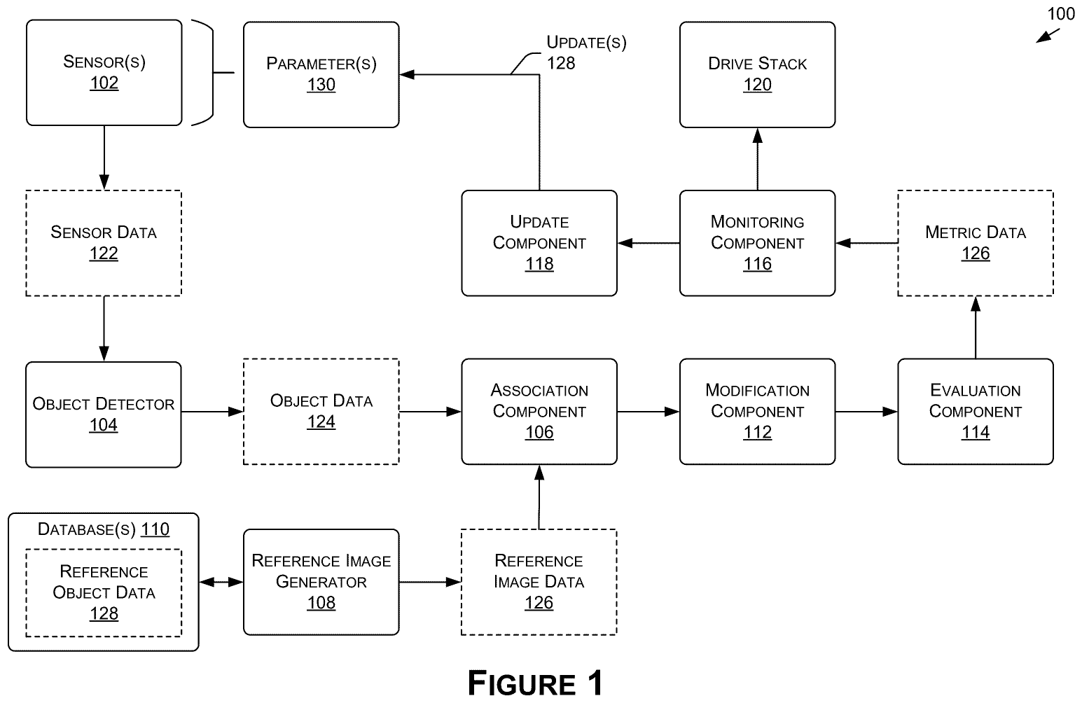

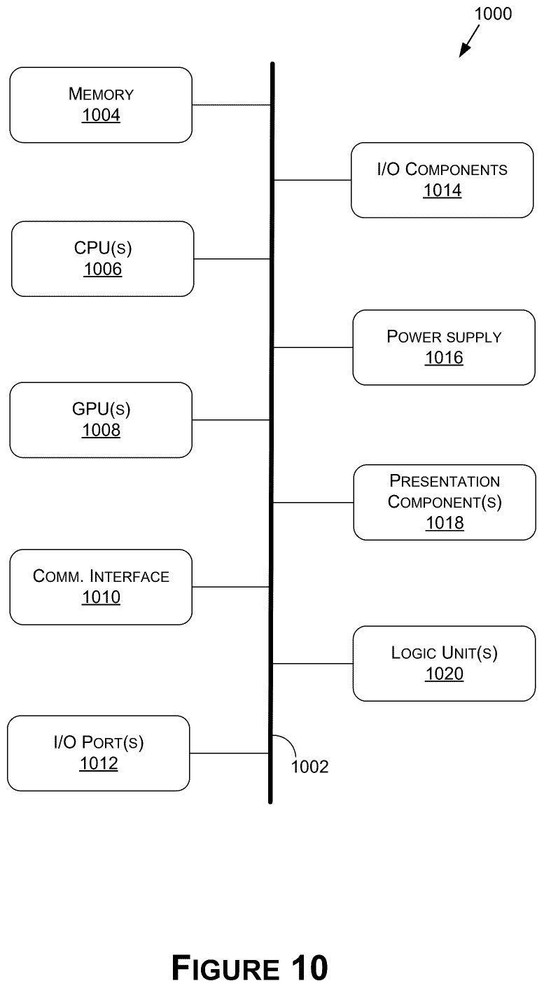

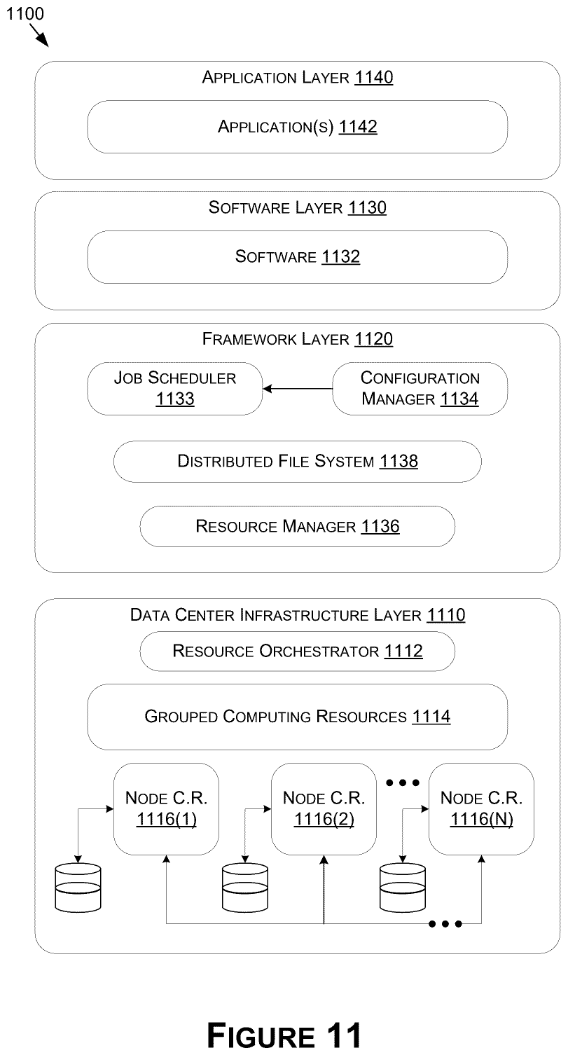

With reference to FIG. 1, FIG. 1 illustrates an example data flow diagram for a process 100 of monitoring sensor functionality, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory. In some embodiments, the systems, methods, and processes described herein may be executed using similar components, features, and/or functionality to those of example autonomous vehicle 900 of FIGS. 9A-9D, example computing device 1000 of FIG. 10, and/or example data center 1100 of FIG. 11.

The process 100 may be implemented using, amongst additional or alternative components, a sensor(s) 102, an object detector 104, an association component 106, a reference image generator 108, a database(s) 110, a modification component 112, an evaluation component 114, a monitoring component 116, an update component 118, and a drive stack 120.

As an overview, the process 100 may include the object detector 104 receiving sensor data 122 generated by the sensor(s) 102. The object detector 104 may process the sensor data 122 and detect one or more objects (e.g., target objects), and output object data 124 associated with the objects. The association component 106 may associate one or more objects in the object data 124 with one or more reference objects depicted in one or more reference images represented using reference image data 126. For instance, the reference image generator 108 may obtain reference object data 128 from the database(s) 110, and use the reference object data 128 to generate the reference image data 126. The modification component 112 may modify the object data 124 such that spatial characteristics of the object correspond to spatial characteristics of the reference object of the reference image data 126, or vice-versa. Then, the evaluation component 114 may evaluate the modified object data 124 with respect to the reference image data 126 (or evaluate the modified reference image data 126 with respect to the object data 124) to generate metric data 128 indicating one or more metrics associated with difference between the compared data. The monitoring component 116 may then use the metric data 126 to monitor the performance of the sensor(s) 102. In some examples, the monitoring component 116 may invoke the update component 118 to apply an update(s) 128 to a parameter(s) 130 associated with the sensor(s) 102. Additionally, or alternatively, the monitoring component 116 may send data related to the performance of the sensor(s) 102 to the drive stack 120 of a machine, and the drive stack 120 may cause the machine to perform one or more operations based at least on the data.

In some examples, the sensor(s) 102 may be a sensor(s) of one or more machines operating in an environment. The machine(s) may include autonomous or semi-autonomous machines, such as an autonomous or semi-autonomous vehicle. For instance, the sensor(s) 102 may correspond to one or more of the sensors described with respect to the machine 900. The sensor(s) 102 may include any type of sensor(s), such as an image sensor (e.g., camera), a LiDAR sensor, a RADAR sensor, an ultrasonic sensor, or any other type of sensor. As such, the sensor data 122 may include any type of sensor data, such as image data representing an image(s), LiDAR data, RADAR data, ultrasonic data, etc. While many of the examples in the present disclosure are explained with respect to using image data to monitor the performance of image sensors, this is not intended to be limiting, and in additional or alternative examples any type of sensor data may be used to monitor the performance of any type of sensor.

As described herein, the sensor(s) 102 may generate or otherwise obtain the sensor data 122 while a machine is operating in an environment. In the case of the sensor data 122 including or corresponding to image data, the image data may represent an image (e.g., captured image) of the environment, which may include one or more objects. Such objects may include, but are not limited to, other machines or vehicles (e.g., other autonomous, semi-autonomous, and/or non-autonomous machines or vehicles), pedestrians, buildings, road signs, traffic lights, utility infrastructure, fixtures, animals, and/or vegetation. In some examples, the system(s) of the present disclosure may detect the presence of a specific object(s) in the environment that is depicted in an image, and the system(s) may compare at least a portion of the image—such as a cropped portion(s) of the image that corresponds to just the specific object(s)—to an ideal, reference image(s) of the same or similar object(s) (e.g., reference object) to evaluate the performance of the image sensor used to generate the image data representing the image. For example, the system(s) may compare images of road signs (e.g., or other signs or generic objects) to ideal, reference images of those same types of road signs to monitor the performance of image sensors.

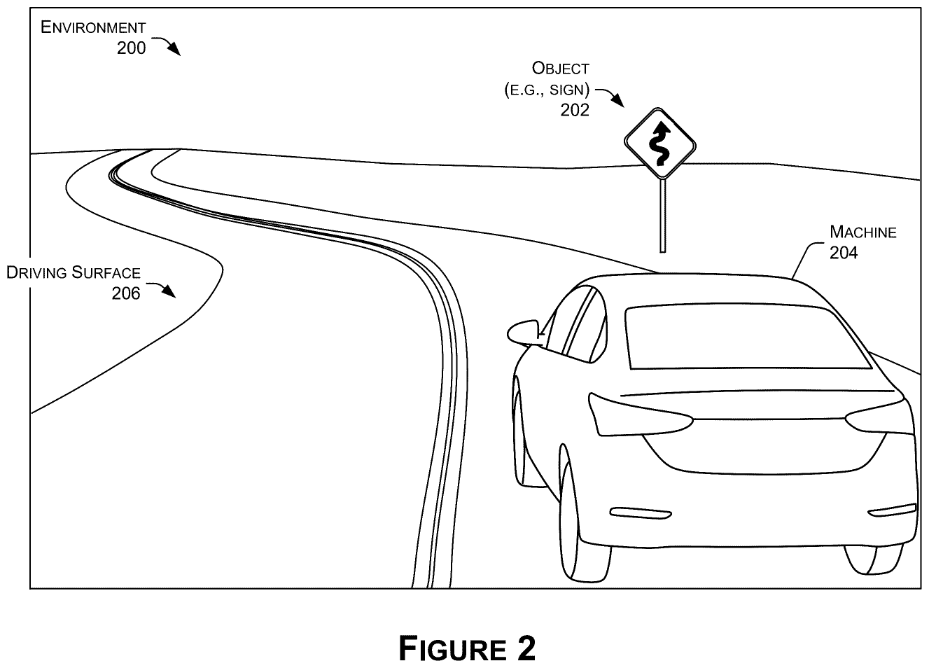

For instance, FIG. 2 illustrates an example of an environment 200 that includes an object 202 that is capable of being used to monitor sensor performance, in accordance with some embodiments of the present disclosure. As illustrated in the example of FIG. 2, a machine 204 (which may correspond to the machine 900) is traversing a driving surface 206 in the environment 200, and the object 202 is a road sign proximate the driving surface 206 and indicating that a winding or curving section of the driving surface 206 is ahead. The machine 204 may include one or more sensors, such as the sensor(s) 102 described with respect to the example of FIG. 1, and the performance (e.g., functionality, integrity, accuracy, health, data quality, etc.) of the sensors may be monitored using sensor data corresponding to the object 202. For example, the machine 204 may include image sensors that capture images of the object 202, and these captured images may be compared with the ideal, reference images of the object 202 or a similar/same object of the object 202, as described herein.

Referring back to the example of FIG. 1, the process 100 may include the object detector 104 obtaining the sensor data 122 and outputting the object data 124 associated with the objects (e.g., road signs, etc.) detected in the environment using the sensor data 122. In some examples, the sensor data 122 may be captured in one format (e.g., RCCB, RCCC, RBGC, etc.), and then converted (e.g., during pre-processing of the sensor data) to another format. In some other examples, the sensor data 122 may be provided as input to a sensor data or image data pre-processor (not shown) to generate pre-processed image data. Many types of images or formats may be used as inputs; for example, compressed images such as in Joint Photographic Experts Group (JPEG), Red Green Blue (RGB), or Luminance/Chrominance (YUV) formats, compressed images as frames stemming from a compressed video format (e.g., H.264/Advanced Video Coding (AVC), H.265/High Efficiency Video Coding (HEVC), VP8, VP9, Alliance for Open Media Video 1 (AV1), Versatile Video Coding (VVC), or any other video compression standard), raw images such as originating from Red Clear Blue (RCCB), Red Clear (RCCC) or other type of imaging sensor. In some examples, different formats and/or resolutions could be used for training the models of the system(s)—such as the models of the object detector 104 described herein—than for inferencing (e.g., during deployment of the models in a machine). Additionally, while many of the examples described herein are in the context of imaging systems that may rely on visible light, the systems of the present disclosure are also applicable to imaging systems that rely on non-visible light, such as infrared (IR), short-wave infrared (SWIR), long-wave infrared (LWIR), and/or ultra-violet (UV).

A sensor data or image data pre-processor may use data representative of one or more images (or other data representations, such as LiDAR depth maps) and load the sensor data into memory in the form of a multi-dimensional array/matrix (alternatively referred to as tensor, or more specifically an input tensor, in some examples). The array size may be computed and/or represented as W×H×C, where W stands for the image width in pixels, H stands for the height in pixels, and C stands for the number of color channels. Without loss of generality, other types and orderings of input image components are also possible. In some embodiments, batching may be used for training and/or for inference. In such examples, the batch size B may be used as a dimension (e.g., an additional fourth dimension). Thus, the input tensor may represent an array of dimension W×H×C×B. Any ordering of the dimensions may be possible, which may depend on the particular hardware and software used to implement the sensor data or image data pre-processor. This ordering may be chosen to maximize training and/or inference performance of the downstream components, such as the object detector 104, the association component 106, the modification component 112, the evaluation component 114, etc.

In some embodiments, a pre-processing image pipeline may be employed by the sensor data or image data pre-processor to process a raw image(s) acquired by the sensor(s) 102 and included in the sensor data 122 to produce pre-processed image data or sensor data which may represent an input image(s) to the input layer(s) (e.g., feature extraction layers) of one or more neural networks of the downstream components. An example of a suitable pre-processing image pipeline may use a raw RCCB Bayer (e.g., 1-channel) type of image from the sensor and convert that image to a RCB (e.g., 3-channel) planar image stored in Fixed Precision (e.g., 16-bit-per-channel) format. The pre-processing image pipeline may include decompanding, noise reduction, demosaicing, white balancing, histogram computing, and/or adaptive global tone mapping (e.g., in that order, or in an alternative order).

Where noise reduction is employed by the image data pre-processor, it may include bilateral denoising in the Bayer domain. Where demosaicing is employed by the image data pre-processor, it may include bilinear interpolation. Where histogram computing is employed by the sensor data or image data pre-processor, it may involve computing a histogram for the C channel, and may be merged with the decompanding or noise reduction in some examples. Where adaptive global tone mapping is employed by the sensor data or image data pre-processor, it may include performing an adaptive gamma-log transform. This may include calculating a histogram, getting a mid-tone level, and/or estimating a maximum luminance with the mid-tone level.

In some examples, such as if the sensor data 122 includes the image data, the object data 124 generated by the object detector 104 may include portions of the image data that correspond to the detected objects. For instance, the object data 124 may include one or more portions of the image data representing cropped images depicting the detected objects. In some examples, the object detector 104 may be configured to detect and generate the object data 124 for all object types in the environment. Additionally, or alternatively, the object detector 104 may be configured to detect and generate the object data 124 for specific types of objects (e.g., the target objects) in the environment, such as road signs or other objects that may be used to monitor the performance of the sensor(s) 102.

In some examples, the object detector 104 may use various object detection and/or semantic segmentation techniques to identify target objects or regions depicted in captured images. The target objects the object detector 104 identifies may be objects for which the database(s) 110 maintain reference object data 128 corresponding to the target objects. As described herein, in at least one example the target objects may include any type of road signs, such as stop signs, speed limit signs, yield signs, crosswalk signs, railroad crossing signs, caution signs, road information signs (e.g., winding road signs, corner signs, multi-lane signs, etc.), wildlife crossing signs, do not enter signs, wrong way signs, or any other road signs. The database(s) 110 may store the reference object data 128, which may represent one or more reference images (e.g., high resolution images, vector graphic images, etc.) depicting these and/or other objects. However, these are just some examples, and in additional or alternative embodiments the target objects may include any other type of object for which a reference object/image is maintained.

In some examples, the object detector 104 may use one or more object detection models to process the sensor data 122 and generate the object data 124. For instance, the object detector 104 may apply one or more captured images to the object detection models, and the object detection models may process the captured images and determine, among other things, that the captured images include target objects (e.g., road signs, road surface markings, generic objects, etc.), identities of the target objects (e.g., stop sign, yield sign, etc.), where the target objects or regions are located, the orientation or geometries of the target objects, and/or any other information associated with the target objects and/or the captured images. The object detection models of the object detector 104 may include, in some instances, one or more machine learning models (e.g., one or more deep neural networks (DNN(s)), one or more convolutional neural networks (CNN(s)), etc.), one or more computer-vision algorithms, one or more traditional algorithmic processes, or any other type of models.

As an example, such as where the DNN(s) includes a CNN, the DNN(s) may include any number of layers. One or more of the layers may include an input layer. The input layer may hold values associated with a captured image(s) represented by the sensor data 122 (e.g., before or after post-processing). For example, the input layer may hold values representative of the pixel values of the captured image(s) as a volume (e.g., a width or angle of the field of view of the LiDAR sensor, an elevation, a depth, and/or an intensity channel).

One or more of the layers may include convolutional layers. The convolutional layers may compute the output of neurons that are connected to local regions in an input layer, each neuron computing a dot product between their weights and a small region they are connected to in the input volume. A result of the convolutional layers may be another volume, with one of the dimensions based on the number of filters applied.

One or more of the layers may include a rectified linear unit (ReLU) layer. The ReLU layer(s) may apply an elementwise activation function, such as the max(0, x), thresholding at zero, for example. The resulting volume of a ReLU layer may be the same as the volume of the input of the ReLU layer.

One or more of the layers may include a pooling layer. The pooling layer may perform a down sampling operation along the spatial dimensions (e.g., the height and the width), which may result in a smaller volume than the input of the pooling layer (e.g., 16×16×12 from a 32×32×12 input volume).

One or more of the layers may include one or more fully connected layer(s). Each neuron in the fully connected layer(s) may be connected to each of the neurons in the previous volume. In some examples, the CNN may include a fully connected layer(s) such that the output of one or more of the layers of the CNN may be provided as input to a fully connected layer(s) of the CNN. In some examples, one or more convolutional streams may be implemented by the DNN(s), and some or all of the convolutional streams may include a respective fully connected layer(s).

In some non-limiting embodiments, the DNN(s) may include a series of convolutional and max pooling layers to facilitate image feature extraction, followed by multi-scale dilated convolutional and up-sampling layers to facilitate global context feature extraction. Although input layers, convolutional layers, pooling layers, ReLU layers, and fully connected layers are discussed herein with respect to the DNN(s), this is not intended to be limiting. For example, additional or alternative layers may be used in the DNN(s), such as normalization layers, SoftMax layers, and/or other layer types.

In embodiments where the DNN(s) includes a CNN, different orders and/or numbers of the layers of the CNN may be used depending on the embodiment. In other words, the order and number of layers of the DNN(s) is not limited to any one architecture. In addition, some of the layers may include parameters (e.g., weights and/or biases), such as the convolutional layers and the fully connected layers, while others may not, such as the ReLU layers and pooling layers. In some examples, the parameters may be learned by the DNN(s) during training. Further, some of the layers may include additional hyper-parameters (e.g., learning rate, stride, epochs, etc.), such as the convolutional layers, the fully connected layers, and the pooling layers, while other layers may not, such as the ReLU layers. The parameters and hyper-parameters are not to be limited and may differ depending on the embodiment.

Although examples are described herein with respect to using neural networks, and specifically DNNs and/or CNNs in machine learning models, this is not intended to be limiting. For example, and without limitation, any of the various machine learning models described herein may include any type of machine learning model, such as a machine learning model(s) using linear regression, logistic regression, decision trees, support vector machines (SVM), Naïve Bayes, k-nearest neighbor (Knn), K means clustering, random forest, dimensionality reduction algorithms, gradient boosting algorithms, neural networks (e.g., auto-encoders, convolutional, recurrent, perceptrons, Long/Short Term Memory (LSTM), Hopfield, Boltzmann, deep belief, deconvolutional, generative adversarial, liquid state machine, etc.), and/or other types of machine learning models.

In some instances, if the object detector 104 and/or the model(s) of the object detector 104 (e.g., DNN, CNN, computer vision, etc.) are unable to classify, identify, detect, etc. the target object from a long distance, the system(s) may retroactively apply the proposed image quality measurement to the remote target object once the machine has approached close enough for successful object classification, with the help of an existing moving trajectory of the object provided by the autonomous driving system. That is, if the object detector 104 is unable to detect an object from afar (e.g., because of poor sensor performance), the system(s) may retroactively determine image quality metrics for the sensor(s) 102 if the reason the object detector 104 was unable to detect the object was because of the quality of the sensor data 122.

The process 100 may also include the association component 106 determining one or more associations between the object data 124 and the reference image data 126. The reference image data 126 may represent reference images depicting reference objects, and the reference image data 126 may be generated by the reference image generator 108 using the reference object data 128. For example, the reference image generator 108 may synthetically generate, render, or derive the reference image data 126 from the reference object data 128, which may represent high-resolution ideal image captures. In some examples, the association component 106 may determine, using the object data 124, that reference images or models are maintained for one or more of the objects, and the association component 106 may signal to the reference image generator 108 to generate the reference image data 126 corresponding to the object data 124.

In at least one example, the reference object data 128 and/or the reference image data 126 may include image data representing one or more images previously generated by the sensor(s) 102, and depicting the same object(s) as depicted in the object data 124. For instance, during a previous session, the sensor(s) 102 may generate sensor data 122 associated with a sign at a specific geolocation in the environment. This sensor data 122 may be stored in the database(s) 110, and then used (e.g., as a baseline or benchmark) at a later time to monitor the performance of the sensor(s) 102. That is, a previous image of an object may be compared to a current image of the object to evaluate the performance of the sensor(s) 102. Additionally, or alternatively, a first image(s) generated using a first sensor(s) (e.g., of a first machine) may be compared to a second image(s) generated using a second sensor(s) (e.g., of the first machine or one or more second machines) to evaluate the performance of the first sensor(s) and/or the second sensor(s).

In some examples, the association component 106 may compute a descriptor for each key point of the captured images and the reference images. The descriptors may encode the appearance of the key point's neighborhood and allow for comparing key points robustly. The association component 106 may then, in some instances, compare the descriptors between the two sets of key points (e.g., the key points from the captured image and the key points form the reference image) to find matches. In some examples, the association component 106 may use a distance measure like Euclidean distance for SIFT or Hamming distance for ORB. Additionally, the association component 106 may employ strategies such as Nearest Neighbors or the Lowe's ratio test to filter strong matches.

In some examples, the association component 106 may use traditional computer vision algorithms (e.g., Scale-Invariant Feature Transform (SIFT), Oriented FAST and Rotated BRIEF (ORB), etc.) to identify key points (or features) in both the object data 124 representing the portion(s) of the captured image(s) and in the reference image data 126 by applying a feature detector to both images to find the key points, which may correspond to corners, edges, or blobs in the images.

Once the object data 124—which may represent one or more cropped images of target objects—has been associated with the reference image data 126 representing the images of the reference objects, the modification component 112 may modify the object data 124 and/or the reference image data 126. As described herein, in some instances the captured image and/or the reference image may be modified for the comparison such that spatial characteristics of the object/reference object are similar or the same in both the image and the reference image. For instance, if the spatial characteristics associated with the object depicted in the captured image differ (e.g., by more than a threshold) from those of the reference object in the reference image, the modification component 112 may update (e.g., modify, transform, skew, warp, etc.) the captured image (e.g., the object data 124) and/or the reference image (e.g., the reference image data 126) to align the objects depicted in the images.

For example, the modification component 112 may estimate spatial features (e.g., shape, orientation, angle, and/or geometry) of the target object in the captured image and use the estimation to determine a spatial transform to update the captured image or the reference image such that the spatial features of the object and the reference objects correspond with one another. As an example, if the captured image of the object depicts the object as being viewed from an angled perspective (e.g., 10-degrees, 20-degrees, etc.) and the reference image depicts the reference object as being viewed straight on (e.g., 0-degrees), the modification component 112 may modify the captured image or the reference image so that both objects are depicted from the same perspective and have the same or similar geometric and/or spatial features (e.g., both objects appear the same in both images). In some examples, the modification component 112 may use velocity information provided by RADAR and/or other sensors to emulate motion blur, which may make the reference images of the target object correspond more closely to the captured image of the target object, improving the accuracy of the image quality measurements or other metrics.

In at least one example, to modify the captured images or the reference images to correspond to one another, the modification component 112 may determine and use a homography matrix to transform one or more coordinates of the captured image to a coordinate system associated with the reference image, or vice-versa. Additionally, in some examples the modification component 112 may interpolate pixel values to account for non-integer coordinates in the transformed space. For instance, the modification component 112 may use bilinear or bicubic interpolation to interpolate the pixel values.

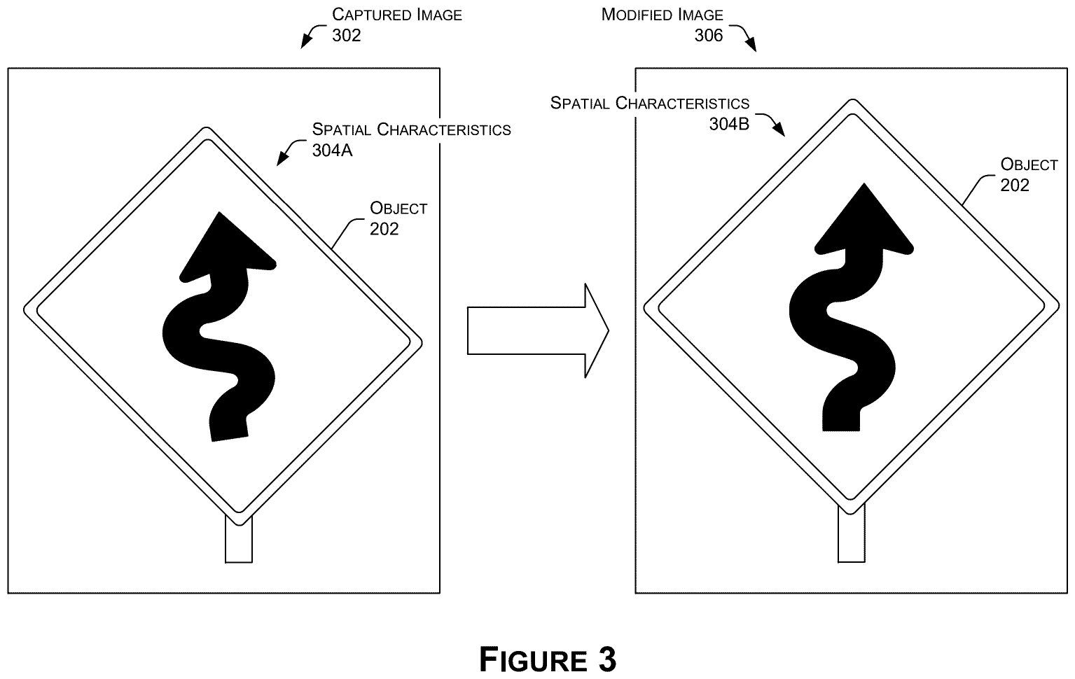

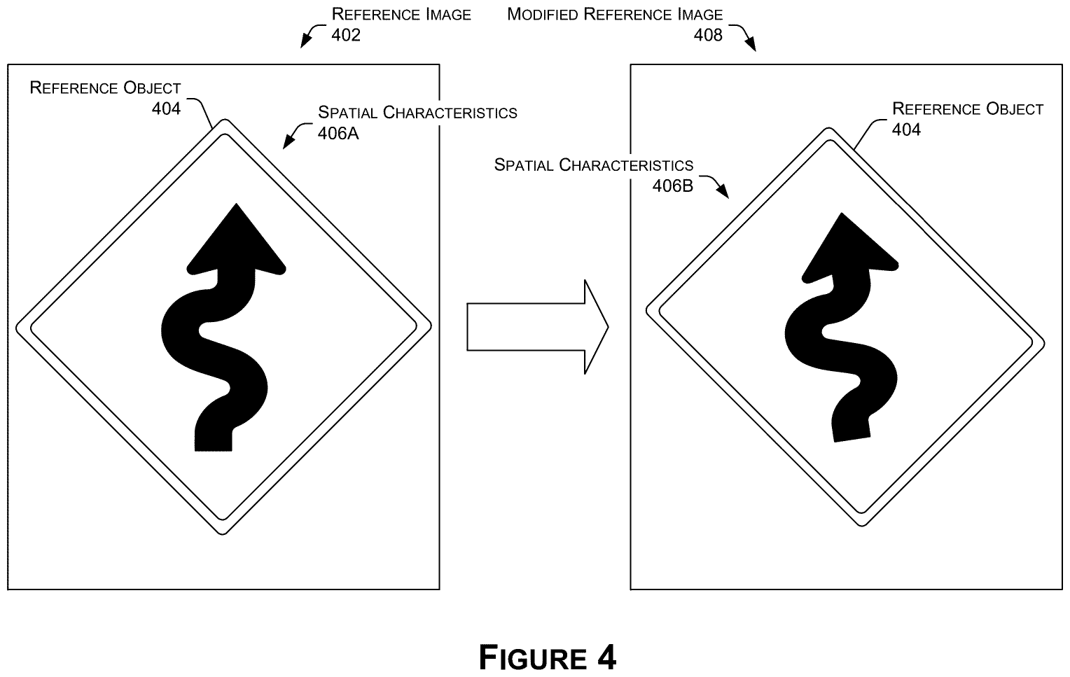

As a first example of the modification component 112 modifying a captured image to update spatial features of a depicted object to correspond to spatial features of a reference object depicted in a reference image, FIG. 3 illustrates an example of modifying a captured image 302 of the object 202 depicted in the example of FIG. 2, in accordance with some embodiments of the present disclosure. For instance, the modification component 112 may update the captured image 302 depicting the object 202 as having first spatial characteristics 304A to generate a modified image 306 depicting the object 202 as having second spatial characteristics 304B. As shown, in the captured image 302 the object 202 may be skewed or otherwise unsymmetrical based on the angle of the object 202 relative to the camera when the image was captured. However, after the modification of the image by the modification component 112, the object 202 is symmetrically depicted in the modified image 306. As described herein, the second spatial characteristics 304B associated with the object 202 depicted in the modified image 306 may correspond to spatial characteristics associated with a reference object depicted in a reference image, such as the first spatial characteristics 406A associated with the reference object 404 depicted in the reference image 402 in the example of FIG. 4.

As a second example of the modification component 112 modifying a reference image to update spatial features of a depicted reference object to correspond to the spatial features of a target object depicted in a captured image, FIG. 4 illustrates an example of modifying a reference image 402 of a reference object 404 that corresponds to the object 202 depicted in the example of FIG. 2, in accordance with some embodiments of the present disclosure. For instance, the modification component 112 may update the reference image 402 depicting the reference object 404 as having first spatial characteristics 406A to generate a modified reference image 408 depicting the reference object 404 as having second spatial characteristics 406B. As shown, in the reference image 402 the reference object 404 may initially be symmetrical. However, after the modification of the reference image 402 by the modification component 112, the reference object 404 is warped or otherwise unsymmetrical in the modified reference image 408. As described herein, the second spatial characteristics 406B associated with the reference object 404 depicted in the modified reference image 408 may correspond to spatial characteristics associated with the object 202 depicted in the captured image 302.

Referring back to the example of FIG. 1, although as being separate components, in some examples, the object detector 104, the association component 106 and the modification component 112 may be combined and use deep learning algorithms/models—such as homography learning with deep learning, unsupervised learning, reinforced learning, etc. —or computer vision algorithms to identify features, match features, compute homography, and update the captured images of the objects to match the reference images of the reference objects in terms of shape, orientation, position, angle, geometry, etc. For instance, the system(s) of the present disclosure may train a neural network (or other type of machine learning model) to predict a homography matrix directly from pairs of images to use homography learning with deep learning. That is, the system(s) may, in some instances, train one or more CNNs that take a pair of images (e.g., captured image of target object and reference image of the same target object) as inputs and then output the parameters of the homography matrix. The CNN(s) may be trained by the system(s) to extract relevant features and understand the spatial relationships between the two images. For instance, the system(s) may train the CNN(s) using a training dataset of image pairs with known homographies, and a loss function may be designed to minimize the difference between the predicted homography and the ground-truth homography.

In some examples, the system(s) may use unsupervised learning to learn feature representations without explicitly labeled data. For example, the system(s) may use autoencoders to learn efficient representations of images that highlight their distinctive features, facilitating better matching between images. Generative Adversarial Networks (GANs) may be used to generate synthetic image pairs with known transformations, including homographies, which may then be used to train a model in a supervised manner without manually labeled data.

As described herein, once the spatial and/or geometric characteristics of the captured image/object correspond to the reference image/object in terms of shape, orientation, position, angle, geometry, etc., the process 100 may include the evaluation component 114 comparing the images to compute various image quality metrics represented by the metric data 126. In some examples, the image quality metrics may include, but may not be limited to, point spread function (PSF) values, modulation transfer function (MTF) values, noise equivalent quanta (NEQ) values, edge spread function values, Delta E values, tone reproduction values, contrast values, color fidelity/error values, lighting values, noise values, Detective Quantum Efficiency (DQE) values, Noise Power Spectrum (NPS) values, information capacity values, separation of target to background values, dynamic range values, Signal-to-Noise Ratio (SNR) values, Ideal Observer SNR (SNRI) values, separation of target to background values, color separability or color separation probability values, chroma artifacts values, “ghosts” values, aliasing values, ringing values, and chromatic aberration values. The metric data 126 may be indicative of differences in image quality between the captured images and the reference images. For instance, the metric data 126 may include metrics/values that indicate a measure of how blurry the captured image is (e.g., relative to the reference image or a baseline image), a measure of how bright the captured image is, etc.

The process 100 may also include the monitoring component 116, which may monitor the performance of the sensor(s) 102 over time using the metric data 126, and perform one or more operations based on the monitoring. For instance, if the monitoring component 116 determines that the performance or health of the sensor(s) 102 has degraded below a threshold, the monitoring component 116 may invoke the update component 118 to perform the update(s) 128 of the parameter(s) 130 associated with the sensor(s) 102. For instance, the parameter(s) 102 may correspond to ISP setting parameters associated with the sensor(s) 102, and the update component 118 may feed the metric data 126 back to the ISP associated with the sensor(s) 102 to optimize the tuning parameters (e.g., sharpening, color correction matrix (CCM), noise reduction, tone mapping, gamma, white balance, etc.) and improve image quality of the sensor(s) 102.

Additionally, in some examples, the monitoring component 116 may send data to the drive stack 120 of the machine indicating the health or performance associated with the sensor(s) 102. For instance, the monitoring component 116 may signal to the drive stack 120 that the performance of the sensor(s) 102 has degraded below a threshold performance level. The drive stack 120 may then perform one or more operations associated with the machine. For instance, the drive stack 120 may associate a lower confidence level with the sensor(s) 102 and or the sensor data 122 so that other components of the machine (e.g., detection components, path planning components, perception components, etc.) make more informed decisions with awareness that the data of the sensor(s) 102 may be inaccurate. Additionally, the drive stack 120 may modify a behavior of the machine, such as a driving behavior. For instance, the drive stack 120 may cause the machine to operate at a lower average speed, increased following distance, increased clearance distance between objects to the left or right of the machine, etc. While these are just some examples, in additional or alternative examples, the drive stack 120 and/or the monitoring component 116 may cause performance of any operations associated with the machine or another machine based at least on the monitoring of the sensor(s) 102 performance.

In some instances, the system(s) may backward project the object depicted in the captured image back to a common three-dimensional (3D) coordinate system that is shared between different modalities of the sensor(s) 102, such as image sensors, LiDAR sensors, RADAR sensors, etc. to obtain depth and velocity information associated with the target object. By backward projecting the object and obtaining the depth and velocity information, the system(s) may be able to associate the calculated MTF and/or PSF with depth since MTF and PSF vary with depth. In various examples, as the machine moves closer to the target object (e.g., moves toward a traffic sign from a distance), the system(s) may calculate the MTF and/or PSF at each depth as the machine approaches the target object.

Additionally, in some examples, the system(s) of the present disclosure may identify non-idealities or imperfections associated with target objects. For instance, and for target objects that include traffic signs, the system(s) may identify paint deterioration, bent sheet metal (of the sign), bent signposts, vandalism/graffiti, concealment by vegetation, adhered substances, dirt substances, dents, etc. As a fleet of autonomous machines may constantly use sensors similar to the sensor(s) 102 to generate images or other sensor data associated with the same target objects in an environment from various angles, distances, speeds, etc., the system(s) may update the reference images for those target objects through comparisons between captured images of the target objects over time. Additionally, the system(s) may update the reference images or otherwise introduce these imperfections to the reference images for those target objects, minimizing the impact of the imperfections/non-idealities when computing image quality metrics associated with an image sensor. In other words, if a sign has deteriorated, the system(s) may keep track of the deterioration of that sign so that the system(s) do not mistake an image of the deteriorated sign for poor sensor performance/image quality.

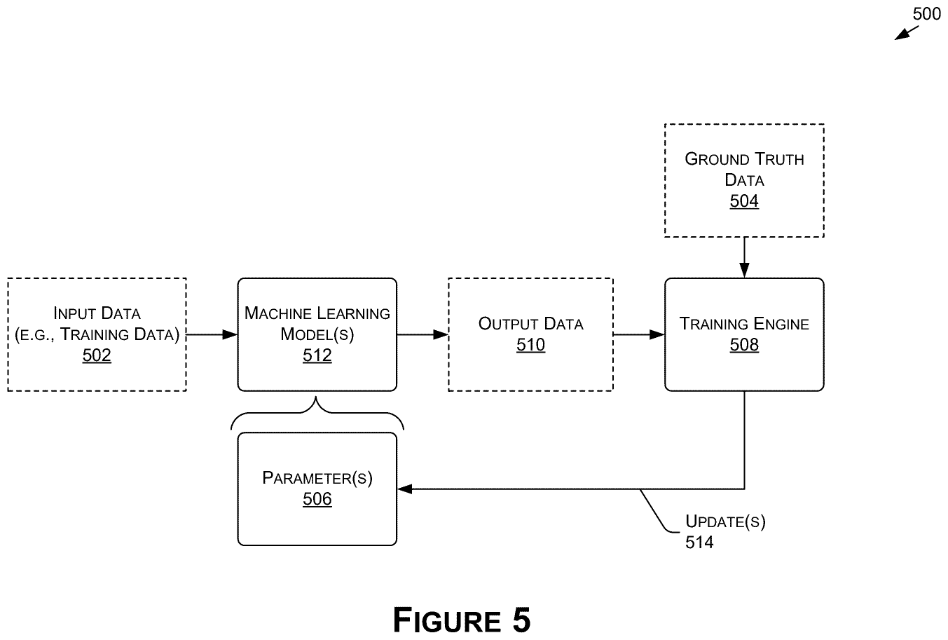

With reference now to FIG. 5, FIG. 5 is a data flow diagram illustrating an example process 500 for training one or more machine learning models 512 to perform one or more operations associated with monitoring sensor performance, in accordance with some embodiments of the present disclosure. For instance, the machine learning model(s) 512 may be trained to perform one or more of the operations described as being performed by the object detector 104, the association component 106, and/or the modification component 112 described herein. As described above and herein, the system(s) of the present disclosure may use the machine learning model(s) 512 to identify features, match features, compute homography, and/or update the captured images of the objects to match the reference images of the reference objects in terms of shape, orientation, position, angle, geometry, etc.

In some examples, the system(s) may train the machine learning model(s) 512 to predict homography matrices directly from pairs of images to use homography learning with deep learning. For instance, the system(s) may train the machine learning model(s) 512 to receive a pair of images (e.g., captured image of target object and reference image of the same target object) as inputs and output the parameters of the homography matrices. The machine learning model(s) 512 may be trained by the system(s) to extract relevant features and understand the spatial relationships between the two images. For instance, the system(s) may train the machine learning model(s) 512 using a training dataset of image pairs (input data 502) with known homographies, and a loss function may be designed to minimize the difference between the predicted homography (output data 510) and the ground-truth homography represented by the ground truth data 504.

In some examples, the system(s) may use unsupervised learning to train the machine learning model(s) 512 to learn feature representations without explicitly labeled data. For example, the system(s) may use autoencoders to train the machine learning model(s) 512 to learn efficient representations of images that highlight their distinctive features, facilitating better matching between images. Generative Adversarial Networks (GANs) may be used to generate synthetic image pairs with known transformations, including homographies, which may then be used to train the machine learning model(s) 512 in a supervised manner without manually labeled data.

As shown, the machine learning model(s) 512 may be trained using input data 502 (e.g., training data). The input data 502 may comprise image data pairs similar to the sensor data 122 (e.g., the input data 502 may comprise image data representing images of one or more target objects, such as road signs) and the reference image data 126 (e.g., the input data 502 may comprise image data representing reference images of one or more reference objects). The machine learning model(s) 512 may be trained using the training input data 502 as well as corresponding ground truth data 504 (which may correspond to the input data 502). In some examples, the ground truth data 504 may include annotations, labels, masks, and/or the like. For example, in some embodiments, the ground truth data 504 may indicate actual values associated with the object(s) within the image data. For instance, and for an object, the values may include, but are not limited to, a x-coordinate location, a y-coordinate location, a z-coordinate location, a height, a width, a length, a density, RGB values, prediction(s), homography matrix values, and/or any other parameters. The ground truth data 504 may be generated within a drawing program (e.g., an annotation program), a computer aided design (CAD) program, a labeling program, another type of program suitable for generating the ground truth data 504, and/or may be hand drawn, in some examples. In any example, the ground truth data 504 may be synthetically produced (e.g., generated from computer models or renderings), real produced (e.g., designed and produced from real-world data), machine-automated (e.g., using feature analysis and learning to extract features from data and then generate labels), human annotated (e.g., labeler, or annotation expert, defines the location of the labels), and/or a combination thereof (e.g., human identifies vertices of polylines, machine generates polygons using polygon rasterizer).

A training engine 508 may use one or more loss functions that measure loss (e.g., error) in the output data 510 generated by the machine learning model(s) 512 as compared to the ground truth data 504 and/or the input data 502. In some examples, the training engine 508 may compare the output data 510 from the machine learning model(s) 512 to the input data 502 (e.g., input images), and update 514 one or more parameters 506 of the machine learning model(s) 512 based at least on the comparing. That is, the training engine 508 may update/optimize one or more parameters 506 associated with the machine learning model(s) 512 to reduce the losses/differences between the output data 510 (e.g., homography matrices, modified images, etc.) and the ground truth data 504 (e.g., ground truth homography matrices, ground truth images, etc.). Any type of loss function may be used, such as cross entropy loss, mean squared error, mean absolute error, mean bias error, and/or other loss function types. In some examples, different outputs may have different loss functions. For example, the x-coordinate location may include a first loss, the y-coordinate location may include a second loss, the z-coordinate location may include a third loss, and/or so forth. In such examples, the loss functions may be combined to form a total loss, and the total loss may be used to train (e.g., update the parameters of) the machine learning model(s) 512. In any example, backward pass computations may be performed to recursively compute gradients of the loss function(s) with respect to training parameters. In some examples, weight and biases of the machine learning model(s) 512 may be used to compute these gradients.

In some examples, the machine learning model 702 may be packaged as a microservice—such an inference microservice (e.g., NVIDIA NIMs)—which may include a container (e.g., an operating system (OS)-level virtualization package) that may include an application programming interface (API) layer, a server layer, a runtime layer, and/or a model “engine. ” For example, the inference microservice may include the container itself and the model 702 (e.g., weights and biases). In some instances, such as where the machine learning model 702 is small enough (e.g., has a small enough number of parameters), the model 702 may be included within the container itself. In some embodiments, the machine learning models 702 described herein may be deployed as an inference microservice to accelerate deployment of models on any cloud, data center, or edge computing system, while ensuring the data is secure. For example, the inference microservice may include one or more APIs, a pre-configured container for simplified deployment, an optimized inference engine (e.g., built using a standardized AI model deployment an execution software, such as NVIDIA's Triton Inference Server, and/or one or more APIs for high performance deep learning inference, which may include an inference runtime and model optimizations that deliver low latency and high throughput for production applications—such as NVIDIA's TensorRT), and/or enterprise management data for telemetry (e.g., including identity, metrics, health checks, and/or monitoring). The machine learning model(s) 702 described herein may be included as part of the microservice along with an accelerated infrastructure with the ability to deploy with a single command and/or orchestrate and auto-scale with a container orchestration system on accelerated infrastructure (e.g., on a single device up to data center scale). As such, the inference microservice may include the machine learning model(s) 702 (e.g., that has been optimized for high performance inference), an inference runtime software to execute the machine learning model(s) 702 and provide outputs/responses to inputs (e.g., user queries, prompts, etc.), and enterprise management software to provide health checks, identity, and other monitoring. In some embodiments, the inference microservice may include software to perform in-place replacement and/or updating to the machine learning model(s) 702. When replacing or updating, the software that performs the replacement/updating may maintain user configurations of the inference runtime software and enterprise management software.

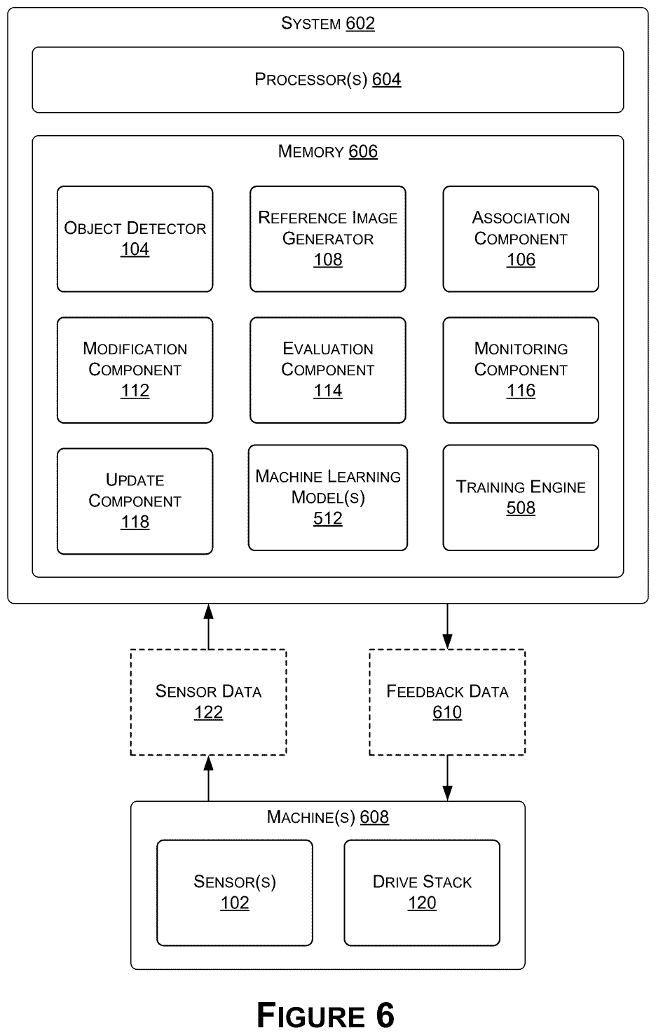

Referring now to FIG. 6, FIG. 6 illustrates an example of a system 602 that may perform one or more of the processes described herein, in accordance with some embodiments of the present disclosure. As shown, the system 602 (which may represent, and/or include, the example computing device(s) 1000 and/or the example data center 1100) may include one or more processors 604 (which may be similar to, and/or include, the CPUs 1006 and/or the GPUs 1008) and memory 606 (which may be similar to, and/or include, the memory 1004). For instance, the memory 606 may store the object detector 104, the reference image generator 108, the association component 106, the modification component 112, the evaluation component 114, the monitoring component 116, the update component 118, the machine learning model(s) 512, and the training engine 508. Additionally, the processor(s) 604 may execute the object detector 104, the reference image generator 108, the association component 106, the modification component 112, the evaluation component 114, the monitoring component 116, the update component 118, the machine learning model(s) 512, and the training engine 508 to perform one or more of the processes described herein.

For instance, the system 602 may receive the sensor data 122 generated by the sensor(s) 102 of one or more machines 608, which may correspond to the machine 204 or the machine 900. The system 602 may then process and evaluate the quality of the sensor data 122 in order to monitor the performance of the sensor(s) 102 of the machine(s) 608. The system 602 may send feedback data 610 to the machine(s) 608 indicating the health of the sensor(s) 102. The drive stack 120 of the machine(s) 608 may use the feedback data 610 to influence and determine one or more control operations of the machine(s) 608. Additionally, the feedback data 610 may be used to update parameters of the sensor(s) 102 and improve its performance, in some examples.

Although depicted as being separate systems, the system 602 and the machine(s) 608 may, in some examples, be the same or different systems. For instance, the processor(s) 604 and the memory 606 may be part of the machine(s) 608 (e.g., included within a computing device of the machine(s) 608).

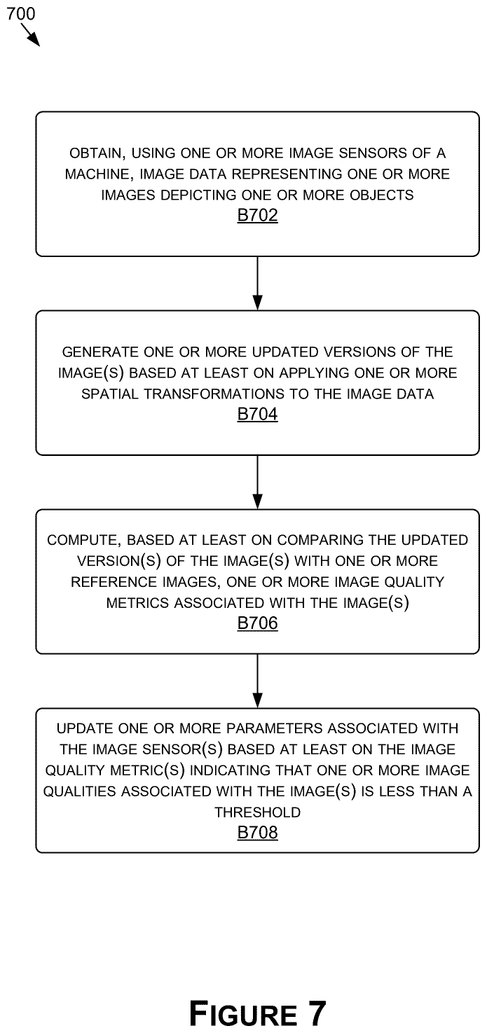

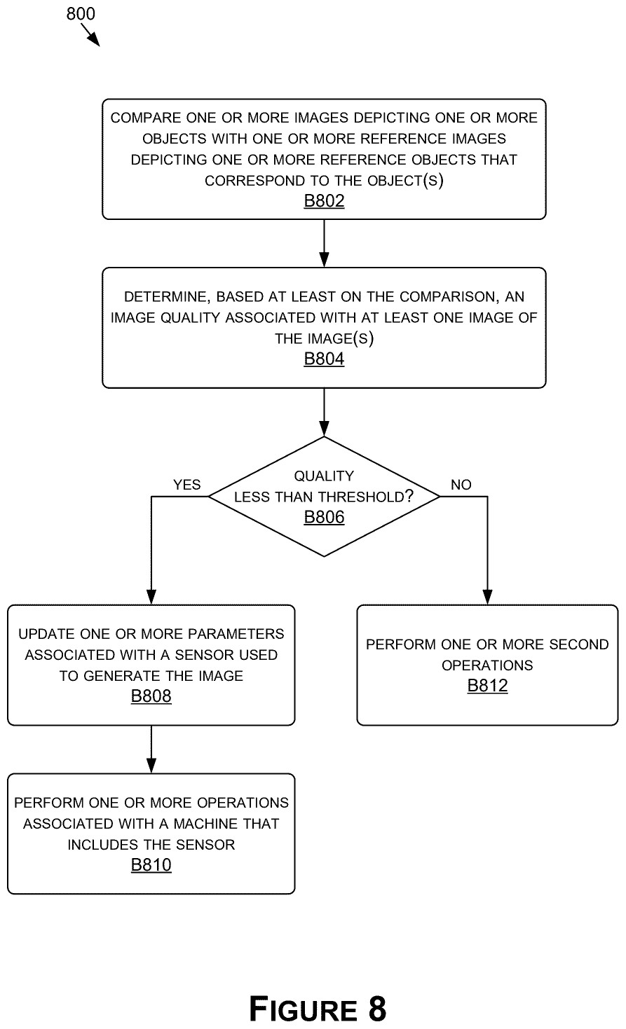

Now referring to FIGS. 7 and 8, each block of methods 700 and 800, described herein, comprises a computing process that may be performed using any combination of hardware, firmware, and/or software. For instance, various functions may be carried out by a processor executing instructions stored in memory. The methods may also be embodied as computer-usable instructions stored on computer storage media. The methods may be provided by a standalone application, a service or hosted service (standalone or in combination with another hosted service), or a plug-in to another product, to name a few. In addition, methods 700 and 800 are described, by way of example, with respect to FIG. 1. However, these methods may additionally or alternatively be executed by any one system, or any combination of systems, including, but not limited to, those described herein.

FIG. 7 is a flow diagram illustrating an example method 700 associated with monitoring sensor performance over time and updating sensor parameters to improve sensor performance, in accordance with some embodiments of the present disclosure. The method 700, at block B702, may include obtaining, using one or more image sensors of a machine, image data representing one or more images depicting one or more objects. For instance, the object detector 104 may obtain the sensor data 122 that includes or corresponds to the image data representing the image(s) depicting the object(s). In some examples, the sensor(s) 102 of the machine may generate the sensor data 122.

The method 700, at block B704, may include generating one or more updated versions of the image(s) based at least on applying one or more spatial transformations to the image data. For instance, the modification component 112 may generate the update version(s) of the image(s) based at least on applying the spatial transformation(s) to the image data. In some examples, the application of the spatial transformation(s) may update one or more first spatial characteristics associated with the one or more objects to correspond to one or more second spatial characteristics associated with one or more reference objects.

The method 700, at block B706, may include computing, based at least on comparing the updated version(s) of the image(s) with one or more reference images, one or more image quality metrics associated with the image(s). For instance, the evaluation component 114 may compute the metric data 126 representing the image quality metric(s) associated with the image(s) based at least on comparing the updated version(s) of the image(s) with the reference image(s).

The method 700, at block B708, may include updating one or more parameters associated with the image sensor(s) based at least on the image quality metric(s) indicating that one or more image qualities associated with the image(s) is less than a threshold. For instance, the update component 118 may update the parameter(s) 130 associated with the sensor(s) 102 based at least on the metric data 126 indicating the image quality(ies) associated with the image(s) is less than the threshold.

FIG. 8 is a flow diagram illustrating an example method 800 for comparing images of objects with reference images of object to monitor sensor functionality, in accordance with some embodiments of the present disclosure. The method 800, at block B802, may include comparing one or more images depicting one or more objects with one or more reference images depicting one or more reference objects that correspond to the object(s). For instance, the evaluation component 114 may compare the image(s) depicting the object(s) with the reference image(s) depicting the reference object(s).

The method 800, at block B804, may include determining, based at least on the comparison, an image quality associated with at least one image of the image(s). For instance, the monitoring component 116 may determine the image quality associated with the image based at least on the comparison. That is, the monitoring component 116 may, in some examples, evaluate the metric data 126 to determine the image quality.

The method 800, at block B806, may include evaluating the image quality with respect to a threshold. For instance, the monitoring component 116 may evaluate the image quality with respect to the threshold. If the image quality is less than the threshold, the method 800 may proceed to block B808. However, if the image quality meets or exceeds the threshold, the method 800 may proceed to block B812. In some examples, evaluating the image quality with respect to the threshold may include evaluating one or more values of one or more metrics associated with the image with respect to one or more threshold values for those metrics.

The method 800, at block B808, may include updating one or more parameters associated with a sensor used to generate the image. For instance, the update component 118 may update the parameter(s) 130 associated with the sensor(s) 102. In some examples, the parameter(s) 130 may correspond to ISP setting parameters associated with an image sensor of the sensor(s) 102.

Additionally, or alternatively, the method 800, at block B810, may include performing one or more operations associated with a machine that includes the sensor. For instance, the drive stack 120 may receive an indication that the performance of the sensor(s) 102 is below the threshold, and the drive stack 120 may cause the machine to perform one or more operations responsive to the indication. In some examples, the operation(s) may include disengaging the machine, decreasing an average speed of the machine, assigning a lower confidence to outputs based on the low quality sensor data, etc.

The method 800, at block B812, may include performing one or more second operations. In some examples, the second operation(s) may include indicating that the sensor is functioning properly or as expected. Additionally, or alternatively, the second operation(s) may include storing the image of the object as a reference image of the object for subsequent iterations of monitoring the performance of the sensor and/or other sensors. For instance, if the image quality is above a threshold, the system(s) may store the image of the object as a new reference image (e.g., baseline image) for evaluating the performance of other sensors or evaluating the performance of the sensor as it ages.

### EXAMPLE AUTONOMOUS VEHICLE

FIG. 9A is an illustration of an example autonomous vehicle 900, in accordance with some embodiments of the present disclosure. The autonomous vehicle 900 (alternatively referred to herein as the “vehicle 900”) may include, without limitation, a passenger vehicle, such as a car, a truck, a bus, a first responder vehicle, a shuttle, an electric or motorized bicycle, a motorcycle, a fire truck, a police vehicle, an ambulance, a boat, a construction vehicle, an underwater craft, a robotic vehicle, a drone, an airplane, a vehicle coupled to a trailer (e.g., a semi-tractor-trailer truck used for hauling cargo), and/or another type of vehicle (e.g., that is unmanned and/or that accommodates one or more passengers). Autonomous vehicles are generally described in terms of automation levels, defined by the National Highway Traffic Safety Administration (NHTSA), a division of the US Department of Transportation, and the Society of Automotive Engineers (SAE) “Taxonomy and Definitions for Terms Related to Driving Automation Systems for On-Road Motor Vehicles” (Standard No. J3016-201806, published on Jun. 15, 2018, Standard No. J3016-201609, published on Sep. 30, 2016, and previous and future versions of this standard). The vehicle 900 may be capable of functionality in accordance with one or more of Level 3—Level 5 of the autonomous driving levels. The vehicle 900 may be capable of functionality in accordance with one or more of Level 1—Level 5 of the autonomous driving levels. For example, the vehicle 900 may be capable of driver assistance (Level 1), partial automation (Level 2), conditional automation (Level 3), high automation (Level 4), and/or full automation (Level 5), depending on the embodiment. The term “autonomous,” as used herein, may include any and/or all types of autonomy for the vehicle 900 or other machine, such as being fully autonomous, being highly autonomous, being conditionally autonomous, being partially autonomous, providing assistive autonomy, being semi-autonomous, being primarily autonomous, or other designation.

The vehicle 900 may include components such as a chassis, a vehicle body, wheels (e.g., 2, 4, 6, 8, 18, etc.), tires, axles, and other components of a vehicle. The vehicle 900 may include a propulsion system 950, such as an internal combustion engine, hybrid electric power plant, an all-electric engine, and/or another propulsion system type. The propulsion system 950 may be connected to a drive train of the vehicle 900, which may include a transmission, to enable the propulsion of the vehicle 900. The propulsion system 950 may be controlled in response to receiving signals from the throttle/accelerator 952.

A steering system 954, which may include a steering wheel, may be used to steer the vehicle 900 (e.g., along a desired path or route) when the propulsion system 950 is operating (e.g., when the vehicle is in motion). The steering system 954 may receive signals from a steering actuator 956. The steering wheel may be optional for full automation (Level 5) functionality.

The brake sensor system 946 may be used to operate the vehicle brakes in response to receiving signals from the brake actuators 948 and/or brake sensors.

Controller(s) 936, which may include one or more system on chips (SoCs) 904 (FIG. 9C) and/or GPU(s), may provide signals (e.g., representative of commands) to one or more components and/or systems of the vehicle 900. For example, the controller(s) may send signals to operate the vehicle brakes via one or more brake actuators 948, to operate the steering system 954 via one or more steering actuators 956, to operate the propulsion system 950 via one or more throttle/accelerators 952. The controller(s) 936 may include one or more onboard (e.g., integrated) computing devices (e.g., supercomputers) that process sensor signals, and output operation commands (e.g., signals representing commands) to enable autonomous driving and/or to assist a human driver in driving the vehicle 900. The controller(s) 936 may include a first controller 936 for autonomous driving functions, a second controller 936 for functional safety functions, a third controller 936 for artificial intelligence functionality (e.g., computer vision), a fourth controller 936 for infotainment functionality, a fifth controller 936 for redundancy in emergency conditions, and/or other controllers. In some examples, a single controller 936 may handle two or more of the above functionalities, two or more controllers 936 may handle a single functionality, and/or any combination thereof.

The controller(s) 936 may provide the signals for controlling one or more components and/or systems of the vehicle 900 in response to sensor data received from one or more sensors (e.g., sensor inputs). The sensor data may be received from, for example and without limitation, global navigation satellite systems (“GNSS”) sensor(s) 958 (e.g., Global Positioning System sensor(s)), RADAR sensor(s) 960, ultrasonic sensor(s) 962, LIDAR sensor(s) 964, inertial measurement unit (IMU) sensor(s) 966 (e.g., accelerometer(s), gyroscope(s), magnetic compass(es), magnetometer(s), etc.), microphone(s) 996, stereo camera(s) 968, wide-view camera(s) 970 (e.g., fisheye cameras), infrared camera(s) 972, surround camera(s) 974 (e.g., 360 degree cameras), long-range and/or mid-range camera(s) 998, speed sensor(s) 944 (e.g., for measuring the speed of the vehicle 900), vibration sensor(s) 942, steering sensor(s) 940, brake sensor(s) (e.g., as part of the brake sensor system 946), and/or other sensor types.

One or more of the controller(s) 936 may receive inputs (e.g., represented by input data) from an instrument cluster 932 of the vehicle 900 and provide outputs (e.g., represented by output data, display data, etc.) via a human-machine interface (HMI) display 934, an audible annunciator, a loudspeaker, and/or via other components of the vehicle 900. The outputs may include information such as vehicle velocity, speed, time, map data (e.g., the High Definition (“HD”) map 922 of FIG. 9C), location data (e.g., the vehicle's 900 location, such as on a map), direction, location of other vehicles (e.g., an occupancy grid), information about objects and status of objects as perceived by the controller(s) 936, etc. For example, the HMI display 934 may display information about the presence of one or more objects (e.g., a street sign, caution sign, traffic light changing, etc.), and/or information about driving maneuvers the vehicle has made, is making, or will make (e.g., changing lanes now, taking exit 34B in two miles, etc.).

The vehicle 900 further includes a network interface 924 which may use one or more wireless antenna(s) 926 and/or modem(s) to communicate over one or more networks. For example, the network interface 924 may be capable of communication over Long-Term Evolution (“LTE”), Wideband Code Division Multiple Access (“WCDMA”), Universal Mobile Telecommunications System (“UMTS”), Global System for Mobile communication (“GSM”), IMT-CDMA Multi-Carrier (“CDMA2000”), etc. The wireless antenna(s) 926 may also enable communication between objects in the environment (e.g., vehicles, mobile devices, etc.), using local area network(s), such as Bluetooth, Bluetooth Low Energy (“LE”), Z-Wave, ZigBee, etc., and/or low power wide-area network(s) (“LPWANs”), such as LoRaWAN, SigFox, etc.

FIG. 9B is an example of camera locations and fields of view for the example autonomous vehicle 900 of FIG. 9A, in accordance with some embodiments of the present disclosure. The cameras and respective fields of view are one example embodiment and are not intended to be limiting. For example, additional and/or alternative cameras may be included and/or the cameras may be located at different locations on the vehicle 900.

The camera types for the cameras may include, but are not limited to, digital cameras that may be adapted for use with the components and/or systems of the vehicle 900. The camera(s) may operate at automotive safety integrity level (ASIL) B and/or at another ASIL. The camera types may be capable of any image capture rate, such as 60 frames per second (fps), 120 fps, 240 fps, etc., depending on the embodiment. The cameras may be capable of using rolling shutters, global shutters, another type of shutter, or a combination thereof. In some examples, the color filter array may include a red clear clear clear (RCCC) color filter array, a red clear clear blue (RCCB) color filter array, a red blue green clear (RBGC) color filter array, a Foveon X3 color filter array, a Bayer sensors (RGGB) color filter array, a monochrome sensor color filter array, and/or another type of color filter array. In some embodiments, clear pixel cameras, such as cameras with an RCCC, an RCCB, and/or an RBGC color filter array, may be used in an effort to increase light sensitivity.

In some examples, one or more of the camera(s) may be used to perform advanced driver assistance systems (ADAS) functions (e.g., as part of a redundant or fail-safe design). For example, a Multi-Function Mono Camera may be installed to provide functions including lane departure warning, traffic sign assist and intelligent headlamp control. One or more of the camera(s) (e.g., all of the cameras) may record and provide image data (e.g., video) simultaneously.

One or more of the cameras may be mounted in a mounting assembly, such as a custom designed (three dimensional (“3D”) printed) assembly, in order to cut out stray light and reflections from within the car (e.g., reflections from the dashboard reflected in the windshield mirrors) which may interfere with the camera's image data capture abilities. With reference to wing-mirror mounting assemblies, the wing-mirror assemblies may be custom 3D printed so that the camera mounting plate matches the shape of the wing-mirror. In some examples, the camera(s) may be integrated into the wing-mirror. For side-view cameras, the camera(s) may also be integrated within the four pillars at each corner of the cabin.

Cameras with a field of view that include portions of the environment in front of the vehicle 900 (e.g., front-facing cameras) may be used for surround view, to help identify forward facing paths and obstacles, as well aid in, with the help of one or more controllers 936 and/or control SoCs, providing information critical to generating an occupancy grid and/or determining the preferred vehicle paths. Front-facing cameras may be used to perform many of the same ADAS functions as LIDAR, including emergency braking, pedestrian detection, and collision avoidance. Front-facing cameras may also be used for ADAS functions and systems including Lane Departure Warnings (“LDW”), Autonomous Cruise Control (“ACC”), and/or other functions such as traffic sign recognition.

A variety of cameras may be used in a front-facing configuration, including, for example, a monocular camera platform that includes a complementary metal oxide semiconductor (“CMOS”) color imager. Another example may be a wide-view camera(s) 970 that may be used to perceive objects coming into view from the periphery (e.g., pedestrians, crossing traffic or bicycles). Although only one wide-view camera is illustrated in FIG. 9B, there may be any number (including zero) of wide-view cameras 970 on the vehicle 900. In addition, any number of long-range camera(s) 998 (e.g., a long-view stereo camera pair) may be used for depth-based object detection, especially for objects for which a neural network has not yet been trained. The long-range camera(s) 998 may also be used for object detection and classification, as well as basic object tracking.

Any number of stereo cameras 968 may also be included in a front-facing configuration. In at least one embodiment, one or more of stereo camera(s) 968 may include an integrated control unit comprising a scalable processing unit, which may provide a programmable logic (“FPGA”) and a multi-core micro-processor with an integrated Controller Area Network (“CAN”) or Ethernet interface on a single chip. Such a unit may be used to generate a 3D map of the vehicle's environment, including a distance estimate for all the points in the image. An alternative stereo camera(s) 968 may include a compact stereo vision sensor(s) that may include two camera lenses (one each on the left and right) and an image processing chip that may measure the distance from the vehicle to the target object and use the generated information (e.g., metadata) to activate the autonomous emergency braking and lane departure warning functions. Other types of stereo camera(s) 968 may be used in addition to, or alternatively from, those described herein.

Cameras with a field of view that include portions of the environment to the side of the vehicle 900 (e.g., side-view cameras) may be used for surround view, providing information used to create and update the occupancy grid, as well as to generate side impact collision warnings. For example, surround camera(s) 974 (e.g., four surround cameras 974 as illustrated in FIG. 9B) may be positioned to on the vehicle 900. The surround camera(s) 974 may include wide-view camera(s) 970, fisheye camera(s), 360 degree camera(s), and/or the like. Four example, four fisheye cameras may be positioned on the vehicle's front, rear, and sides. In an alternative arrangement, the vehicle may use three surround camera(s) 974 (e.g., left, right, and rear), and may leverage one or more other camera(s) (e.g., a forward-facing camera) as a fourth surround view camera.

Cameras with a field of view that include portions of the environment to the rear of the vehicle 900 (e.g., rear-view cameras) may be used for park assistance, surround view, rear collision warnings, and creating and updating the occupancy grid. A wide variety of cameras may be used including, but not limited to, cameras that are also suitable as a front-facing camera(s) (e.g., long-range and/or mid-range camera(s) 998, stereo camera(s) 968), infrared camera(s) 972, etc.), as described herein.

FIG. 9C is a block diagram of an example system architecture for the example autonomous vehicle 900 of FIG. 9A, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

Each of the components, features, and systems of the vehicle 900 in FIG. 9C are illustrated as being connected via bus 902. The bus 902 may include a Controller Area Network (CAN) data interface (alternatively referred to herein as a “CAN bus”). A CAN may be a network inside the vehicle 900 used to aid in control of various features and functionality of the vehicle 900, such as actuation of brakes, acceleration, braking, steering, windshield wipers, etc. A CAN bus may be configured to have dozens or even hundreds of nodes, each with its own unique identifier (e.g., a CAN ID). The CAN bus may be read to find steering wheel angle, ground speed, engine revolutions per minute (RPMs), button positions, and/or other vehicle status indicators. The CAN bus may be ASIL B compliant.

Although the bus 902 is described herein as being a CAN bus, this is not intended to be limiting. For example, in addition to, or alternatively from, the CAN bus, FlexRay and/or Ethernet may be used. Additionally, although a single line is used to represent the bus 902, this is not intended to be limiting. For example, there may be any number of busses 902, which may include one or more CAN busses, one or more FlexRay busses, one or more Ethernet busses, and/or one or more other types of busses using a different protocol. In some examples, two or more busses 902 may be used to perform different functions, and/or may be used for redundancy. For example, a first bus 902 may be used for collision avoidance functionality and a second bus 902 may be used for actuation control. In any example, each bus 902 may communicate with any of the components of the vehicle 900, and two or more busses 902 may communicate with the same components. In some examples, each SoC 904, each controller 936, and/or each computer within the vehicle may have access to the same input data (e.g., inputs from sensors of the vehicle 900), and may be connected to a common bus, such the CAN bus.

The vehicle 900 may include one or more controller(s) 936, such as those described herein with respect to FIG. 9A. The controller(s) 936 may be used for a variety of functions. The controller(s) 936 may be coupled to any of the various other components and systems of the vehicle 900, and may be used for control of the vehicle 900, artificial intelligence of the vehicle 900, infotainment for the vehicle 900, and/or the like.

The vehicle 900 may include a system(s) on a chip (SoC) 904. The SoC 904 may include CPU(s) 906, GPU(s) 908, processor(s) 910, cache(s) 912, accelerator(s) 914, data store(s) 916, and/or other components and features not illustrated. The SoC(s) 904 may be used to control the vehicle 900 in a variety of platforms and systems. For example, the SoC(s) 904 may be combined in a system (e.g., the system of the vehicle 900) with an HD map 922 which may obtain map refreshes and/or updates via a network interface 924 from one or more servers (e.g., server(s) 978 of FIG. 9D).

The CPU(s) 906 may include a CPU cluster or CPU complex (alternatively referred to herein as a “CCPLEX”). The CPU(s) 906 may include multiple cores and/or L2 caches. For example, in some embodiments, the CPU(s) 906 may include eight cores in a coherent multi-processor configuration. In some embodiments, the CPU(s) 906 may include four dual-core clusters where each cluster has a dedicated L2 cache (e.g., a 2 MB L2 cache). The CPU(s) 906 (e.g., the CCPLEX) may be configured to support simultaneous cluster operation enabling any combination of the clusters of the CPU(s) 906 to be active at any given time.

The CPU(s) 906 may implement power management capabilities that include one or more of the following features: individual hardware blocks may be clock-gated automatically when idle to save dynamic power; each core clock may be gated when the core is not actively executing instructions due to execution of WFI/WFE instructions; each core may be independently power-gated; each core cluster may be independently clock-gated when all cores are clock-gated or power-gated; and/or each core cluster may be independently power-gated when all cores are power-gated. The CPU(s) 906 may further implement an enhanced algorithm for managing power states, where allowed power states and expected wakeup times are specified, and the hardware/microcode determines the best power state to enter for the core, cluster, and CCPLEX. The processing cores may support simplified power state entry sequences in software with the work offloaded to microcode.

The GPU(s) 908 may include an integrated GPU (alternatively referred to herein as an “iGPU”). The GPU(s) 908 may be programmable and may be efficient for parallel workloads. The GPU(s) 908, in some examples, may use an enhanced tensor instruction set. The GPU(s) 908 may include one or more streaming microprocessors, where each streaming microprocessor may include an L1 cache (e.g., an L1 cache with at least 96 KB storage capacity), and two or more of the streaming microprocessors may share an L2 cache (e.g., an L2 cache with a 512 KB storage capacity). In some embodiments, the GPU(s) 908 may include at least eight streaming microprocessors. The GPU(s) 908 may use compute application programming interface(s) (API(s)). In addition, the GPU(s) 908 may use one or more parallel computing platforms and/or programming models (e.g., NVIDIA's CUDA).

The GPU(s) 908 may be power-optimized for best performance in automotive and embedded use cases. For example, the GPU(s) 908 may be fabricated on a Fin field-effect transistor (FinFET). However, this is not intended to be limiting and the GPU(s) 908 may be fabricated using other semiconductor manufacturing processes. Each streaming microprocessor may incorporate a number of mixed-precision processing cores partitioned into multiple blocks. For example, and without limitation, 64 PF32 cores and 32 PF64 cores may be partitioned into four processing blocks. In such an example, each processing block may be allocated 16 FP32 cores, 8 FP64 cores, 16 INT32 cores, two mixed-precision NVIDIA TENSOR COREs for deep learning matrix arithmetic, an L0 instruction cache, a warp scheduler, a dispatch unit, and/or a 64 KB register file. In addition, the streaming microprocessors may include independent parallel integer and floating-point data paths to provide for efficient execution of workloads with a mix of computation and addressing calculations. The streaming microprocessors may include independent thread scheduling capability to enable finer-grain synchronization and cooperation between parallel threads. The streaming microprocessors may include a combined L1 data cache and shared memory unit in order to improve performance while simplifying programming.

The GPU(s) 908 may include a high bandwidth memory (HBM) and/or a 16 GB HBM2 memory subsystem to provide, in some examples, about 900 GB/second peak memory bandwidth. In some examples, in addition to, or alternatively from, the HBM memory, a synchronous graphics random-access memory (SGRAM) may be used, such as a graphics double data rate type five synchronous random-access memory (GDDR5).

The GPU(s) 908 may include unified memory technology including access counters to allow for more accurate migration of memory pages to the processor that accesses them most frequently, thereby improving efficiency for memory ranges shared between processors. In some examples, address translation services (ATS) support may be used to allow the GPU(s) 908 to access the CPU(s) 906 page tables directly. In such examples, when the GPU(s) 908 memory management unit (MMU) experiences a miss, an address translation request may be transmitted to the CPU(s) 906. In response, the CPU(s) 906 may look in its page tables for the virtual-to-physical mapping for the address and transmits the translation back to the GPU(s) 908. As such, unified memory technology may allow a single unified virtual address space for memory of both the CPU(s) 906 and the GPU(s) 908, thereby simplifying the GPU(s) 908 programming and porting of applications to the GPU(s) 908.

In addition, the GPU(s) 908 may include an access counter that may keep track of the frequency of access of the GPU(s) 908 to memory of other processors. The access counter may help ensure that memory pages are moved to the physical memory of the processor that is accessing the pages most frequently.

The SoC(s) 904 may include any number of cache(s) 912, including those described herein. For example, the cache(s) 912 may include an L3 cache that is available to both the CPU(s) 906 and the GPU(s) 908 (e.g., that is connected both the CPU(s) 906 and the GPU(s) 908). The cache(s) 912 may include a write-back cache that may keep track of states of lines, such as by using a cache coherence protocol (e.g., MEI, MESI, MSI, etc.). The L₃ cache may include 4 MB or more, depending on the embodiment, although smaller cache sizes may be used.

The SoC(s) 904 may include an arithmetic logic unit(s) (ALU(s)) which may be leveraged in performing processing with respect to any of the variety of tasks or operations of the vehicle 900—such as processing DNNs. In addition, the SoC(s) 904 may include a floating point unit(s) (FPU(s))—or other math coprocessor or numeric coprocessor types—for performing mathematical operations within the system. For example, the SoC(s) 904 may include one or more FPUs integrated as execution units within a CPU(s) 906 and/or GPU(s) 908.

The SoC(s) 904 may include one or more accelerators 914 (e.g., hardware accelerators, software accelerators, or a combination thereof). For example, the SoC(s) 904 may include a hardware acceleration cluster that may include optimized hardware accelerators and/or large on-chip memory. The large on-chip memory (e.g., 4 MB of SRAM), may enable the hardware acceleration cluster to accelerate neural networks and other calculations. The hardware acceleration cluster may be used to complement the GPU(s) 908 and to off-load some of the tasks of the GPU(s) 908 (e.g., to free up more cycles of the GPU(s) 908 for performing other tasks). As an example, the accelerator(s) 914 may be used for targeted workloads (e.g., perception, convolutional neural networks (CNNs), etc.) that are stable enough to be amenable to acceleration. The term “CNN,” as used herein, may include all types of CNNs, including region-based or regional convolutional neural networks (RCNNs) and Fast RCNNs (e.g., as used for object detection).

The accelerator(s) 914 (e.g., the hardware acceleration cluster) may include a deep learning accelerator(s) (DLA). The DLA(s) may include one or more Tensor processing units (TPUs) that may be configured to provide an additional ten trillion operations per second for deep learning applications and inferencing. The TPUs may be accelerators configured to, and optimized for, performing image processing functions (e.g., for CNNs, RCNNs, etc.). The DLA(s) may further be optimized for a specific set of neural network types and floating point operations, as well as inferencing. The design of the DLA(s) may provide more performance per millimeter than a general-purpose GPU, and vastly exceeds the performance of a CPU. The TPU(s) may perform several functions, including a single-instance convolution function, supporting, for example, INT8, INT16, and FP16 data types for both features and weights, as well as post-processor functions.

The DLA(s) may quickly and efficiently execute neural networks, especially CNNs, on processed or unprocessed data for any of a variety of functions, including, for example and without limitation: a CNN for object identification and detection using data from camera sensors; a CNN for distance estimation using data from camera sensors; a CNN for emergency vehicle detection and identification and detection using data from microphones; a CNN for facial recognition and vehicle owner identification using data from camera sensors; and/or a CNN for security and/or safety related events.

The DLA(s) may perform any function of the GPU(s) 908, and by using an inference accelerator, for example, a designer may target either the DLA(s) or the GPU(s) 908 for any function. For example, the designer may focus processing of CNNs and floating point operations on the DLA(s) and leave other functions to the GPU(s) 908 and/or other accelerator(s) 914.

The accelerator(s) 914 (e.g., the hardware acceleration cluster) may include a programmable vision accelerator(s) (PVA), which may alternatively be referred to herein as a computer vision accelerator. The PVA(s) may be designed and configured to accelerate computer vision algorithms for the advanced driver assistance systems (ADAS), autonomous driving, and/or augmented reality (AR) and/or virtual reality (VR) applications. The PVA(s) may provide a balance between performance and flexibility. For example, each PVA(s) may include, for example and without limitation, any number of reduced instruction set computer (RISC) cores, direct memory access (DMA), and/or any number of vector processors.

The RISC cores may interact with image sensors (e.g., the image sensors of any of the cameras described herein), image signal processor(s), and/or the like. Each of the RISC cores may include any amount of memory. The RISC cores may use any of a number of protocols, depending on the embodiment. In some examples, the RISC cores may execute a real-time operating system (RTOS). The RISC cores may be implemented using one or more integrated circuit devices, application specific integrated circuits (ASICs), and/or memory devices. For example, the RISC cores may include an instruction cache and/or a tightly coupled RAM.

The DMA may enable components of the PVA(s) to access the system memory independently of the CPU(s) 906. The DMA may support any number of features used to provide optimization to the PVA including, but not limited to, supporting multi-dimensional addressing and/or circular addressing. In some examples, the DMA may support up to six or more dimensions of addressing, which may include block width, block height, block depth, horizontal block stepping, vertical block stepping, and/or depth stepping.

The vector processors may be programmable processors that may be designed to efficiently and flexibly execute programming for computer vision algorithms and provide signal processing capabilities. In some examples, the PVA may include a PVA core and two vector processing subsystem partitions. The PVA core may include a processor subsystem, DMA engine(s) (e.g., two DMA engines), and/or other peripherals. The vector processing subsystem may operate as the primary processing engine of the PVA, and may include a vector processing unit (VPU), an instruction cache, and/or vector memory (e.g., VMEM). A VPU core may include a digital signal processor such as, for example, a single instruction, multiple data (SIMD), very long instruction word (VLIW) digital signal processor. The combination of the SIMD and VLIW may enhance throughput and speed.

Each of the vector processors may include an instruction cache and may be coupled to dedicated memory. As a result, in some examples, each of the vector processors may be configured to execute independently of the other vector processors. In other examples, the vector processors that are included in a particular PVA may be configured to employ data parallelism. For example, in some embodiments, the plurality of vector processors included in a single PVA may execute the same computer vision algorithm, but on different regions of an image. In other examples, the vector processors included in a particular PVA may simultaneously execute different computer vision algorithms, on the same image, or even execute different algorithms on sequential images or portions of an image. Among other things, any number of PVAs may be included in the hardware acceleration cluster and any number of vector processors may be included in each of the PVAs. In addition, the PVA(s) may include additional error correcting code (ECC) memory, to enhance overall system safety.

The accelerator(s) 914 (e.g., the hardware acceleration cluster) may include a computer vision network on-chip and SRAM, for providing a high-bandwidth, low latency SRAM for the accelerator(s) 914. In some examples, the on-chip memory may include at least 4 MB SRAM, consisting of, for example and without limitation, eight field-configurable memory blocks, that may be accessible by both the PVA and the DLA. Each pair of memory blocks may include an advanced peripheral bus (APB) interface, configuration circuitry, a controller, and a multiplexer. Any type of memory may be used. The PVA and DLA may access the memory via a backbone that provides the PVA and DLA with high-speed access to memory. The backbone may include a computer vision network on-chip that interconnects the PVA and the DLA to the memory (e.g., using the APB).

The computer vision network on-chip may include an interface that determines, before transmission of any control signal/address/data, that both the PVA and the DLA provide ready and valid signals. Such an interface may provide for separate phases and separate channels for transmitting control signals/addresses/data, as well as burst-type communications for continuous data transfer. This type of interface may comply with ISO 26262 or IEC 61508 standards, although other standards and protocols may be used.

In some examples, the SoC(s) 904 may include a real-time ray-tracing hardware accelerator, such as described in U.S. patent application Ser. No. 16/101,232, filed on Aug. 10, 2018. The real-time ray-tracing hardware accelerator may be used to quickly and efficiently determine the positions and extents of objects (e.g., within a world model), to generate real-time visualization simulations, for RADAR signal interpretation, for sound propagation synthesis and/or analysis, for simulation of SONAR systems, for general wave propagation simulation, for comparison to LIDAR data for purposes of localization and/or other functions, and/or for other uses. In some embodiments, one or more tree traversal units (TTUs) may be used for executing one or more ray-tracing related operations.

The accelerator(s) 914 (e.g., the hardware accelerator cluster) have a wide array of uses for autonomous driving. The PVA may be a programmable vision accelerator that may be used for key processing stages in ADAS and autonomous vehicles. The PVA's capabilities are a good match for algorithmic domains needing predictable processing, at low power and low latency. In other words, the PVA performs well on semi-dense or dense regular computation, even on small data sets, which need predictable run-times with low latency and low power. Thus, in the context of platforms for autonomous vehicles, the PVAs are designed to run classic computer vision algorithms, as they are efficient at object detection and operating on integer math.

For example, according to one embodiment of the technology, the PVA is used to perform computer stereo vision. A semi-global matching-based algorithm may be used in some examples, although this is not intended to be limiting. Many applications for Level 3-5 autonomous driving require motion estimation/stereo matching on-the-fly (e.g., structure from motion, pedestrian recognition, lane detection, etc.). The PVA may perform computer stereo vision function on inputs from two monocular cameras.

In some examples, the PVA may be used to perform dense optical flow. According to process raw RADAR data (e.g., using a 4D Fast Fourier Transform) to provide Processed RADAR. In other examples, the PVA is used for time of flight depth processing, by processing raw time of flight data to provide processed time of flight data, for example.

The DLA may be used to run any type of network to enhance control and driving safety, including for example, a neural network that outputs a measure of confidence for each object detection. Such a confidence value may be interpreted as a probability, or as providing a relative “weight” of each detection compared to other detections. This confidence value enables the system to make further decisions regarding which detections should be considered as true positive detections rather than false positive detections. For example, the system may set a threshold value for the confidence and consider only the detections exceeding the threshold value as true positive detections. In an automatic emergency braking (AEB) system, false positive detections would cause the vehicle to automatically perform emergency braking, which is obviously undesirable. Therefore, only the most confident detections should be considered as triggers for AEB. The DLA may run a neural network for regressing the confidence value. The neural network may take as its input at least some subset of parameters, such as bounding box dimensions, ground plane estimate obtained (e.g. from another subsystem), inertial measurement unit (IMU) sensor 966 output that correlates with the vehicle 900 orientation, distance, 3D location estimates of the object obtained from the neural network and/or other sensors (e.g., LIDAR sensor(s) 964 or RADAR sensor(s) 960), among others.

The SoC(s) 904 may include data store(s) 916 (e.g., memory). The data store(s) 916 may be on-chip memory of the SoC(s) 904, which may store neural networks to be executed on the GPU and/or the DLA. In some examples, the data store(s) 916 may be large enough in capacity to store multiple instances of neural networks for redundancy and safety. The data store(s) 912 may comprise L2 or L3 cache(s) 912. Reference to the data store(s) 916 may include reference to the memory associated with the PVA, DLA, and/or other accelerator(s) 914, as described herein.

The SoC(s) 904 may include one or more processor(s) 910 (e.g., embedded processors). The processor(s) 910 may include a boot and power management processor that may be a dedicated processor and subsystem to handle boot power and management functions and related security enforcement. The boot and power management processor may be a part of the SoC(s) 904 boot sequence and may provide runtime power management services. The boot power and management processor may provide clock and voltage programming, assistance in system low power state transitions, management of SoC(s) 904 thermals and temperature sensors, and/or management of the SoC(s) 904 power states. Each temperature sensor may be implemented as a ring-oscillator whose output frequency is proportional to temperature, and the SoC(s) 904 may use the ring-oscillators to detect temperatures of the CPU(s) 906, GPU(s) 908, and/or accelerator(s) 914. If temperatures are determined to exceed a threshold, the boot and power management processor may enter a temperature fault routine and put the SoC(s) 904 into a lower power state and/or put the vehicle 900 into a chauffeur to safe stop mode (e.g., bring the vehicle 900 to a safe stop).

The processor(s) 910 may further include a set of embedded processors that may serve as an audio processing engine. The audio processing engine may be an audio subsystem that enables full hardware support for multi-channel audio over multiple interfaces, and a broad and flexible range of audio I/O interfaces. In some examples, the audio processing engine is a dedicated processor core with a digital signal processor with dedicated RAM.

The processor(s) 910 may further include an always on processor engine that may provide necessary hardware features to support low power sensor management and wake use cases. The always on processor engine may include a processor core, a tightly coupled RAM, supporting peripherals (e.g., timers and interrupt controllers), various I/O controller peripherals, and routing logic.

The processor(s) 910 may further include a safety cluster engine that includes a dedicated processor subsystem to handle safety management for automotive applications. The safety cluster engine may include two or more processor cores, a tightly coupled RAM, support peripherals (e.g., timers, an interrupt controller, etc.), and/or routing logic. In a safety mode, the two or more cores may operate in a lockstep mode and function as a single core with comparison logic to detect any differences between their operations.

The processor(s) 910 may further include a real-time camera engine that may include a dedicated processor subsystem for handling real-time camera management.

The processor(s) 910 may further include a high-dynamic range signal processor that may include an image signal processor that is a hardware engine that is part of the camera processing pipeline.

The processor(s) 910 may include a video image compositor that may be a processing block (e.g., implemented on a microprocessor) that implements video post-processing functions needed by a video playback application to produce the final image for the player window. The video image compositor may perform lens distortion correction on wide-view camera(s) 970, surround camera(s) 974, and/or on in-cabin monitoring camera sensors. In-cabin monitoring camera sensor is preferably monitored by a neural network running on another instance of the Advanced SoC, configured to identify in cabin events and respond accordingly. An in-cabin system may perform lip reading to activate cellular service and place a phone call, dictate emails, change the vehicle's destination, activate or change the vehicle's infotainment system and settings, or provide voice-activated web surfing. Certain functions are available to the driver only when the vehicle is operating in an autonomous mode, and are disabled otherwise.

The video image compositor may include enhanced temporal noise reduction for both spatial and temporal noise reduction. For example, where motion occurs in a video, the noise reduction weights spatial information appropriately, decreasing the weight of information provided by adjacent frames. Where an image or portion of an image does not include motion, the temporal noise reduction performed by the video image compositor may use information from the previous image to reduce noise in the current image.

The video image compositor may also be configured to perform stereo rectification on input stereo lens frames. The video image compositor may further be used for user interface composition when the operating system desktop is in use, and the GPU(s) 908 is not required to continuously render new surfaces. Even when the GPU(s) 908 is powered on and active doing 3D rendering, the video image compositor may be used to offload the GPU(s) 908 to improve performance and responsiveness.

The SoC(s) 904 may further include a mobile industry processor interface (MIPI) camera serial interface for receiving video and input from cameras, a high-speed interface, and/or a video input block that may be used for camera and related pixel input functions. The SoC(s) 904 may further include an input/output controller(s) that may be controlled by software and may be used for receiving I/O signals that are uncommitted to a specific role.

The SoC(s) 904 may further include a broad range of peripheral interfaces to enable communication with peripherals, audio codecs, power management, and/or other devices. The SoC(s) 904 may be used to process data from cameras (e.g., connected over Gigabit Multimedia Serial Link and Ethernet), sensors (e.g., LIDAR sensor(s) 964, RADAR sensor(s) 960, etc. that may be connected over Ethernet), data from bus 902 (e.g., speed of vehicle 900, steering wheel position, etc.), data from GNSS sensor(s) 958 (e.g., connected over Ethernet or CAN bus). The SoC(s) 904 may further include dedicated high-performance mass storage controllers that may include their own DMA engines, and that may be used to free the CPU(s) 906 from routine data management tasks.

The SoC(s) 904 may be an end-to-end platform with a flexible architecture that spans automation levels 3-5, thereby providing a comprehensive functional safety architecture that leverages and makes efficient use of computer vision and ADAS techniques for diversity and redundancy, provides a platform for a flexible, reliable driving software stack, along with deep learning tools. The SoC(s) 904 may be faster, more reliable, and even more energy-efficient and space-efficient than conventional systems. For example, the accelerator(s) 914, when combined with the CPU(s) 906, the GPU(s) 908, and the data store(s) 916, may provide for a fast, efficient platform for level 3-5 autonomous vehicles.

The technology thus provides capabilities and functionality that cannot be achieved by conventional systems. For example, computer vision algorithms may be executed on CPUs, which may be configured using high-level programming language, such as the C programming language, to execute a wide variety of processing algorithms across a wide variety of visual data. However, CPUs are oftentimes unable to meet the performance requirements of many computer vision applications, such as those related to execution time and power consumption, for example. In particular, many CPUs are unable to execute complex object detection algorithms in real-time, which is a requirement of in-vehicle ADAS applications, and a requirement for practical Level 3-5 autonomous vehicles.

In contrast to conventional systems, by providing a CPU complex, GPU complex, and a hardware acceleration cluster, the technology described herein allows for multiple neural networks to be performed simultaneously and/or sequentially, and for the results to be combined together to enable Level 3-5 autonomous driving functionality. For example, a CNN executing on the DLA or dGPU (e.g., the GPU(s) 920) may include a text and word recognition, allowing the supercomputer to read and understand traffic signs, including signs for which the neural network has not been specifically trained. The DLA may further include a neural network that is able to identify, interpret, and provides semantic understanding of the sign, and to pass that semantic understanding to the path planning modules running on the CPU Complex.

As another example, multiple neural networks may be run simultaneously, as is required for Level 3, 4, or 5 driving. For example, a warning sign consisting of “Caution: flashing lights indicate icy conditions,” along with an electric light, may be independently or collectively interpreted by several neural networks. The sign itself may be identified as a traffic sign by a first deployed neural network (e.g., a neural network that has been trained), the text “Flashing lights indicate icy conditions” may be interpreted by a second deployed neural network, which informs the vehicle's path planning software (preferably executing on the CPU Complex) that when flashing lights are detected, icy conditions exist. The flashing light may be identified by operating a third deployed neural network over multiple frames, informing the vehicle's path-planning software of the presence (or absence) of flashing lights. All three neural networks may run simultaneously, such as within the DLA and/or on the GPU(s) 908.

In some examples, a CNN for facial recognition and vehicle owner identification may use data from camera sensors to identify the presence of an authorized driver and/or owner of the vehicle 900. The always on sensor processing engine may be used to unlock the vehicle when the owner approaches the driver door and turn on the lights, and, in security mode, to disable the vehicle when the owner leaves the vehicle. In this way, the SoC(s) 904 provide for security against theft and/or carjacking.

In another example, a CNN for emergency vehicle detection and identification may use data from microphones 996 to detect and identify emergency vehicle sirens. In contrast to conventional systems, that use general classifiers to detect sirens and manually extract features, the SoC(s) 904 use the CNN for classifying environmental and urban sounds, as well as classifying visual data. In a preferred embodiment, the CNN running on the DLA is trained to identify the relative closing speed of the emergency vehicle (e.g., by using the Doppler Effect). The CNN may also be trained to identify emergency vehicles specific to the local area in which the vehicle is operating, as identified by GNSS sensor(s) 958. Thus, for example, when operating in Europe the CNN will seek to detect European sirens, and when in the United States the CNN will seek to identify only North American sirens. Once an emergency vehicle is detected, a control program may be used to execute an emergency vehicle safety routine, slowing the vehicle, pulling over to the side of the road, parking the vehicle, and/or idling the vehicle, with the assistance of ultrasonic sensors 962, until the emergency vehicle(s) passes.

The vehicle may include a CPU(s) 918 (e.g., discrete CPU(s), or dCPU(s)), that may be coupled to the SoC(s) 904 via a high-speed interconnect (e.g., PCIe). The CPU(s) 918 may include an ×86 processor, for example. The CPU(s) 918 may be used to perform any of a variety of functions, including arbitrating potentially inconsistent results between ADAS sensors and the SoC(s) 904, and/or monitoring the status and health of the controller(s) 936 and/or infotainment SoC 930, for example.

The vehicle 900 may include a GPU(s) 920 (e.g., discrete GPU(s), or dGPU(s)), that may be coupled to the SoC(s) 904 via a high-speed interconnect (e.g., NVIDIA's NVLINK). The GPU(s) 920 may provide additional artificial intelligence functionality, such as by executing redundant and/or different neural networks, and may be used to train and/or update neural networks based on input (e.g., sensor data) from sensors of the vehicle 900.

The vehicle 900 may further include the network interface 924 which may include one or more wireless antennas 926 (e.g., one or more wireless antennas for different communication protocols, such as a cellular antenna, a Bluetooth antenna, etc.). The network interface 924 may be used to enable wireless connectivity over the Internet with the cloud (e.g., with the server(s) 978 and/or other network devices), with other vehicles, and/or with computing devices (e.g., client devices of passengers). To communicate with other vehicles, a direct link may be established between the two vehicles and/or an indirect link may be established (e.g., across networks and over the Internet). Direct links may be provided using a vehicle-to-vehicle communication link. The vehicle-to-vehicle communication link may provide the vehicle 900 information about vehicles in proximity to the vehicle 900 (e.g., vehicles in front of, on the side of, and/or behind the vehicle 900). This functionality may be part of a cooperative adaptive cruise control functionality of the vehicle 900.

The network interface 924 may include a SoC that provides modulation and demodulation functionality and enables the controller(s) 936 to communicate over wireless networks. The network interface 924 may include a radio frequency front-end for up-conversion from baseband to radio frequency, and down conversion from radio frequency to baseband. The frequency conversions may be performed through well-known processes, and/or may be performed using super-heterodyne processes. In some examples, the radio frequency front end functionality may be provided by a separate chip. The network interface may include wireless functionality for communicating over LTE, WCDMA, UMTS, GSM, CDMA2000, Bluetooth, Bluetooth LE, Wi-Fi, Z-Wave, ZigBee, LoRaWAN, and/or other wireless protocols.

The vehicle 900 may further include data store(s) 928 which may include off-chip (e.g., off the SoC(s) 904) storage. The data store(s) 928 may include one or more storage elements including RAM, SRAM, DRAM, VRAM, Flash, hard disks, and/or other components and/or devices that may store at least one bit of data.

The vehicle 900 may further include GNSS sensor(s) 958. The GNSS sensor(s) 958 (e.g., GPS, assisted GPS sensors, differential GPS (DGPS) sensors, etc.), to assist in mapping, perception, occupancy grid generation, and/or path planning functions. Any number of GNSS sensor(s) 958 may be used, including, for example and without limitation, a GPS using a USB connector with an Ethernet to Serial (RS-232) bridge.

The vehicle 900 may further include RADAR sensor(s) 960. The RADAR sensor(s) 960 may be used by the vehicle 900 for long-range vehicle detection, even in darkness and/or severe weather conditions. RADAR functional safety levels may be ASIL B. The RADAR sensor(s) 960 may use the CAN and/or the bus 902 (e.g., to transmit data generated by the RADAR sensor(s) 960) for control and to access object tracking data, with access to Ethernet to access raw data in some examples. A wide variety of RADAR sensor types may be used. For example, and without limitation, the RADAR sensor(s) 960 may be suitable for front, rear, and side RADAR use. In some example, Pulse Doppler RADAR sensor(s) are used.

The RADAR sensor(s) 960 may include different configurations, such as long range with narrow field of view, short range with wide field of view, short range side coverage, etc. In some examples, long-range RADAR may be used for adaptive cruise control functionality. The long-range RADAR systems may provide a broad field of view realized by two or more independent scans, such as within a 250 m range. The RADAR sensor(s) 960 may help in distinguishing between static and moving objects, and may be used by ADAS systems for emergency brake assist and forward collision warning. Long-range RADAR sensors may include monostatic multimodal RADAR with multiple (e.g., six or more) fixed RADAR antennae and a high-speed CAN and FlexRay interface. In an example with six antennae, the central four antennae may create a focused beam pattern, designed to record the vehicle's 900 surroundings at higher speeds with minimal interference from traffic in adjacent lanes. The other two antennae may expand the field of view, making it possible to quickly detect vehicles entering or leaving the vehicle's 900 lane.

Mid-range RADAR systems may include, as an example, a range of up to 960 m (front) or 80 m (rear), and a field of view of up to 42 degrees (front) or 950 degrees (rear). Short-range RADAR systems may include, without limitation, RADAR sensors designed to be installed at both ends of the rear bumper. When installed at both ends of the rear bumper, such a RADAR sensor systems may create two beams that constantly monitor the blind spot in the rear and next to the vehicle.

Short-range RADAR systems may be used in an ADAS system for blind spot detection and/or lane change assist.

The vehicle 900 may further include ultrasonic sensor(s) 962. The ultrasonic sensor(s) 962, which may be positioned at the front, back, and/or the sides of the vehicle 900, may be used for park assist and/or to create and update an occupancy grid. A wide variety of ultrasonic sensor(s) 962 may be used, and different ultrasonic sensor(s) 962 may be used for different ranges of detection (e.g., 2.5 m, 4 m). The ultrasonic sensor(s) 962 may operate at functional safety levels of ASIL B.

The vehicle 900 may include LIDAR sensor(s) 964. The LIDAR sensor(s) 964 may be used for object and pedestrian detection, emergency braking, collision avoidance, and/or other functions. The LIDAR sensor(s) 964 may be functional safety level ASIL B. In some examples, the vehicle 900 may include multiple LIDAR sensors 964 (e.g., two, four, six, etc.) that may use Ethernet (e.g., to provide data to a Gigabit Ethernet switch).

In some examples, the LIDAR sensor(s) 964 may be capable of providing a list of objects and their distances for a 360-degree field of view. Commercially available LIDAR sensor(s) 964 may have an advertised range of approximately 900 m, with an accuracy of 2 cm-3 cm, and with support for a 900 Mbps Ethernet connection, for example. In some examples, one or more non-protruding LIDAR sensors 964 may be used. In such examples, the LIDAR sensor(s) 964 may be implemented as a small device that may be embedded into the front, rear, sides, and/or corners of the vehicle 900. The LIDAR sensor(s) 964, in such examples, may provide up to a 120-degree horizontal and 35-degree vertical field-of-view, with a 200 m range even for low-reflectivity objects. Front-mounted LIDAR sensor(s) 964 may be configured for a horizontal field of view between 45 degrees and 135 degrees.

In some examples, LIDAR technologies, such as 3D flash LIDAR, may also be used. 3D Flash LIDAR uses a flash of a laser as a transmission source, to illuminate vehicle surroundings up to approximately 200 m. A flash LIDAR unit includes a receptor, which records the laser pulse transit time and the reflected light on each pixel, which in turn corresponds to the range from the vehicle to the objects. Flash LIDAR may allow for highly accurate and distortion-free images of the surroundings to be generated with every laser flash. In some examples, four flash LIDAR sensors may be deployed, one at each side of the vehicle 900. Available 3D flash LIDAR systems include a solid-state 3D staring array LIDAR camera with no moving parts other than a fan (e.g., a non-scanning LIDAR device). The flash LIDAR device may use a 5 nanosecond class I (eye-safe) laser pulse per frame and may capture the reflected laser light in the form of 3D range point clouds and co-registered intensity data. By using flash LIDAR, and because flash LIDAR is a solid-state device with no moving parts, the LIDAR sensor(s) 964 may be less susceptible to motion blur, vibration, and/or shock.

The vehicle may further include IMU sensor(s) 966. The IMU sensor(s) 966 may be located at a center of the rear axle of the vehicle 900, in some examples. The IMU sensor(s) 966 may include, for example and without limitation, an accelerometer(s), a magnetometer(s), a gyroscope(s), a magnetic compass(es), and/or other sensor types. In some examples, such as in six-axis applications, the IMU sensor(s) 966 may include accelerometers and gyroscopes, while in nine-axis applications, the IMU sensor(s) 966 may include accelerometers, gyroscopes, and magnetometers.

In some embodiments, the IMU sensor(s) 966 may be implemented as a miniature, high performance GPS-Aided Inertial Navigation System (GPS/INS) that combines micro-electro-mechanical systems (MEMS) inertial sensors, a high-sensitivity GPS receiver, and advanced Kalman filtering algorithms to provide estimates of position, velocity, and attitude. As such, in some examples, the IMU sensor(s) 966 may enable the vehicle 900 to estimate heading without requiring input from a magnetic sensor by directly observing and correlating the changes in velocity from GPS to the IMU sensor(s) 966. In some examples, the IMU sensor(s) 966 and the GNSS sensor(s) 958 may be combined in a single integrated unit.

The vehicle may include microphone(s) 996 placed in and/or around the vehicle 900. The microphone(s) 996 may be used for emergency vehicle detection and identification, among other things.

The vehicle may further include any number of camera types, including stereo camera(s) 968, wide-view camera(s) 970, infrared camera(s) 972, surround camera(s) 974, long-range and/or mid-range camera(s) 998, and/or other camera types. The cameras may be used to capture image data around an entire periphery of the vehicle 900. The types of cameras used depends on the embodiments and requirements for the vehicle 900, and any combination of camera types may be used to provide the necessary coverage around the vehicle 900. In addition, the number of cameras may differ depending on the embodiment. For example, the vehicle may include six cameras, seven cameras, ten cameras, twelve cameras, and/or another number of cameras. The cameras may support, as an example and without limitation, Gigabit Multimedia Serial Link (GMSL) and/or Gigabit Ethernet. Each of the camera(s) is described with more detail herein with respect to FIG. 9A and FIG. 9B.

The vehicle 900 may further include vibration sensor(s) 942. The vibration sensor(s) 942 may measure vibrations of components of the vehicle, such as the axle(s). For example, changes in vibrations may indicate a change in road surfaces. In another example, when two or more vibration sensors 942 are used, the differences between the vibrations may be used to determine friction or slippage of the road surface (e.g., when the difference in vibration is between a power-driven axle and a freely rotating axle).

The vehicle 900 may include an ADAS system 938. The ADAS system 938 may include a SoC, in some examples. The ADAS system 938 may include autonomous/adaptive/automatic cruise control (ACC), cooperative adaptive cruise control (CACC), forward crash warning (FCW), automatic emergency braking (AEB), lane departure warnings (LDW), lane keep assist (LKA), blind spot warning (BSW), rear cross-traffic warning (RCTW), collision warning systems (CWS), lane centering (LC), and/or other features and functionality.

The ACC systems may use RADAR sensor(s) 960, LIDAR sensor(s) 964, and/or a camera(s). The ACC systems may include longitudinal ACC and/or lateral ACC. Longitudinal ACC monitors and controls the distance to the vehicle immediately ahead of the vehicle 900 and automatically adjust the vehicle speed to maintain a safe distance from vehicles ahead. Lateral ACC performs distance keeping, and advises the vehicle 900 to change lanes when necessary. Lateral ACC is related to other ADAS applications such as LCA and CWS.

CACC uses information from other vehicles that may be received via the network interface 924 and/or the wireless antenna(s) 926 from other vehicles via a wireless link, or indirectly, over a network connection (e.g., over the Internet). Direct links may be provided by a vehicle-to-vehicle (V2V) communication link, while indirect links may be infrastructure-to-vehicle (I2V) communication link. In general, the V2V communication concept provides information about the immediately preceding vehicles (e.g., vehicles immediately ahead of and in the same lane as the vehicle 900), while the I2V communication concept provides information about traffic further ahead. CACC systems may include either or both I2V and V2V information sources. Given the information of the vehicles ahead of the vehicle 900, CACC may be more reliable and it has potential to improve traffic flow smoothness and reduce congestion on the road.

FCW systems are designed to alert the driver to a hazard, so that the driver may take corrective action. FCW systems use a front-facing camera and/or RADAR sensor(s) 960, coupled to a dedicated processor, DSP, FPGA, and/or ASIC, that is electrically coupled to driver feedback, such as a display, speaker, and/or vibrating component. FCW systems may provide a warning, such as in the form of a sound, visual warning, vibration and/or a quick brake pulse.

AEB systems detect an impending forward collision with another vehicle or other object, and may automatically apply the brakes if the driver does not take corrective action within a specified time or distance parameter. AEB systems may use front-facing camera(s) and/or RADAR sensor(s) 960, coupled to a dedicated processor, DSP, FPGA, and/or ASIC. When the AEB system detects a hazard, it typically first alerts the driver to take corrective action to avoid the collision and, if the driver does not take corrective action, the AEB system may automatically apply the brakes in an effort to prevent, or at least mitigate, the impact of the predicted collision. AEB systems, may include techniques such as dynamic brake support and/or crash imminent braking.

LDW systems provide visual, audible, and/or tactile warnings, such as steering wheel or seat vibrations, to alert the driver when the vehicle 900 crosses lane markings. A LDW system does not activate when the driver indicates an intentional lane departure, by activating a turn signal. LDW systems may use front-side facing cameras, coupled to a dedicated processor, DSP, FPGA, and/or ASIC, that is electrically coupled to driver feedback, such as a display, speaker, and/or vibrating component.

LKA systems are a variation of LDW systems. LKA systems provide steering input or braking to correct the vehicle 900 if the vehicle 900 starts to exit the lane.

BSW systems detects and warn the driver of vehicles in an automobile's blind spot. BSW systems may provide a visual, audible, and/or tactile alert to indicate that merging or changing lanes is unsafe. The system may provide an additional warning when the driver uses a turn signal. BSW systems may use rear-side facing camera(s) and/or RADAR sensor(s) 960, coupled to a dedicated processor, DSP, FPGA, and/or ASIC, that is electrically coupled to driver feedback, such as a display, speaker, and/or vibrating component.

RCTW systems may provide visual, audible, and/or tactile notification when an object is detected outside the rear-camera range when the vehicle 900 is backing up. Some RCTW systems include AEB to ensure that the vehicle brakes are applied to avoid a crash. RCTW systems may use one or more rear-facing RADAR sensor(s) 960, coupled to a dedicated processor, DSP, FPGA, and/or ASIC, that is electrically coupled to driver feedback, such as a display, speaker, and/or vibrating component.

Conventional ADAS systems may be prone to false positive results which may be annoying and distracting to a driver, but typically are not catastrophic, because the ADAS systems alert the driver and allow the driver to decide whether a safety condition truly exists and act accordingly. However, in an autonomous vehicle 900, the vehicle 900 itself must, in the case of conflicting results, decide whether to heed the result from a primary computer or a secondary computer (e.g., a first controller 936 or a second controller 936). For example, in some embodiments, the ADAS system 938 may be a backup and/or secondary computer for providing perception information to a backup computer rationality module. The backup computer rationality monitor may run a redundant diverse software on hardware components to detect faults in perception and dynamic driving tasks. Outputs from the ADAS system 938 may be provided to a supervisory MCU. If outputs from the primary computer and the secondary computer conflict, the supervisory MCU must determine how to reconcile the conflict to ensure safe operation.

In some examples, the primary computer may be configured to provide the supervisory MCU with a confidence score, indicating the primary computer's confidence in the chosen result. If the confidence score exceeds a threshold, the supervisory MCU may follow the primary computer's direction, regardless of whether the secondary computer provides a conflicting or inconsistent result. Where the confidence score does not meet the threshold, and where the primary and secondary computer indicate different results (e.g., the conflict), the supervisory MCU may arbitrate between the computers to determine the appropriate outcome.

The supervisory MCU may be configured to run a neural network(s) that is trained and configured to determine, based on outputs from the primary computer and the secondary computer, conditions under which the secondary computer provides false alarms. Thus, the neural network(s) in the supervisory MCU may learn when the secondary computer's output may be trusted, and when it cannot. For example, when the secondary computer is a RADAR-based FCW system, a neural network(s) in the supervisory MCU may learn when the FCW system is identifying metallic objects that are not, in fact, hazards, such as a drainage grate or manhole cover that triggers an alarm. Similarly, when the secondary computer is a camera-based LDW system, a neural network in the supervisory MCU may learn to override the LDW when bicyclists or pedestrians are present and a lane departure is, in fact, the safest maneuver. In embodiments that include a neural network(s) running on the supervisory MCU, the supervisory MCU may include at least one of a DLA or GPU suitable for running the neural network(s) with associated memory. In preferred embodiments, the supervisory MCU may comprise and/or be included as a component of the SoC(s) 904.

In other examples, ADAS system 938 may include a secondary computer that performs ADAS functionality using traditional rules of computer vision. As such, the secondary computer may use classic computer vision rules (if-then), and the presence of a neural network(s) in the supervisory MCU may improve reliability, safety and performance. For example, the diverse implementation and intentional non-identity makes the overall system more fault-tolerant, especially to faults caused by software (or software-hardware interface) functionality. For example, if there is a software bug or error in the software running on the primary computer, and the non-identical software code running on the secondary computer provides the same overall result, the supervisory MCU may have greater confidence that the overall result is correct, and the bug in software or hardware on primary computer is not causing material error.

In some examples, the output of the ADAS system 938 may be fed into the primary computer's perception block and/or the primary computer's dynamic driving task block. For example, if the ADAS system 938 indicates a forward crash warning due to an object immediately ahead, the perception block may use this information when identifying objects. In other examples, the secondary computer may have its own neural network which is trained and thus reduces the risk of false positives, as described herein.

The vehicle 900 may further include the infotainment SoC 930 (e.g., an in-vehicle infotainment system (IVI)). Although illustrated and described as a SoC, the infotainment system may not be a SoC, and may include two or more discrete components. The infotainment SoC 930 may include a combination of hardware and software that may be used to provide audio (e.g., music, a personal digital assistant, navigational instructions, news, radio, etc.), video (e.g., TV, movies, streaming, etc.), phone (e.g., hands-free calling), network connectivity (e.g., LTE, Wi-Fi, etc.), and/or information services (e.g., navigation systems, rear-parking assistance, a radio data system, vehicle related information such as fuel level, total distance covered, brake fuel level, oil level, door open/close, air filter information, etc.) to the vehicle 900. For example, the infotainment SoC 930 may radios, disk players, navigation systems, video players, USB and Bluetooth connectivity, carputers, in-car entertainment, Wi-Fi, steering wheel audio controls, hands free voice control, a heads-up display (HUD), an HMI display 934, a telematics device, a control panel (e.g., for controlling and/or interacting with various components, features, and/or systems), and/or other components. The infotainment SoC 930 may further be used to provide information (e.g., visual and/or audible) to a user(s) of the vehicle, such as information from the ADAS system 938, autonomous driving information such as planned vehicle maneuvers, trajectories, surrounding environment information (e.g., intersection information, vehicle information, road information, etc.), and/or other information.

The infotainment SoC 930 may include GPU functionality. The infotainment SoC 930 may communicate over the bus 902 (e.g., CAN bus, Ethernet, etc.) with other devices, systems, and/or components of the vehicle 900. In some examples, the infotainment SoC 930 may be coupled to a supervisory MCU such that the GPU of the infotainment system may perform some self-driving functions in the event that the primary controller(s) 936 (e.g., the primary and/or backup computers of the vehicle 900) fail. In such an example, the infotainment SoC 930 may put the vehicle 900 into a chauffeur to safe stop mode, as described herein.

The vehicle 900 may further include an instrument cluster 932 (e.g., a digital dash, an electronic instrument cluster, a digital instrument panel, etc.). The instrument cluster 932 may include a controller and/or supercomputer (e.g., a discrete controller or supercomputer). The instrument cluster 932 may include a set of instrumentation such as a speedometer, fuel level, oil pressure, tachometer, odometer, turn indicators, gearshift position indicator, seat belt warning light(s), parking-brake warning light(s), engine-malfunction light(s), airbag (SRS) system information, lighting controls, safety system controls, navigation information, etc. In some examples, information may be displayed and/or shared among the infotainment SoC 930 and the instrument cluster 932. In other words, the instrument cluster 932 may be included as part of the infotainment SoC 930, or vice versa.

FIG. 9D is a system diagram for communication between cloud-based server(s) and the example autonomous vehicle 900 of FIG. 9A, in accordance with some embodiments of the present disclosure. The system 976 may include server(s) 978, network(s) 990, and vehicles, including the vehicle 900. The server(s) 978 may include a plurality of GPUs 984(A)-984(H) (collectively referred to herein as GPUs 984), PCIe switches 982(A)-982(H) (collectively referred to herein as PCIe switches 982), and/or CPUs 980(A)-980(B) (collectively referred to herein as CPUs 980). The GPUs 984, the CPUs 980, and the PCIe switches may be interconnected with high-speed interconnects such as, for example and without limitation, NVLink interfaces 988 developed by NVIDIA and/or PCIe connections 986. In some examples, the GPUs 984 are connected via NVLink and/or NVSwitch SoC and the GPUs 984 and the PCIe switches 982 are connected via PCIe interconnects. Although eight GPUs 984, two CPUs 980, and two PCIe switches are illustrated, this is not intended to be limiting. Depending on the embodiment, each of the server(s) 978 may include any number of GPUs 984, CPUs 980, and/or PCIe switches. For example, the server(s) 978 may each include eight, sixteen, thirty-two, and/or more GPUs 984.

The server(s) 978 may receive, over the network(s) 990 and from the vehicles, image data representative of images showing unexpected or changed road conditions, such as recently commenced road-work. The server(s) 978 may transmit, over the network(s) 990 and to the vehicles, neural networks 992, updated neural networks 992, and/or map information 994, including information regarding traffic and road conditions. The updates to the map information 994 may include updates for the HD map 922, such as information regarding construction sites, potholes, detours, flooding, and/or other obstructions. In some examples, the neural networks 992, the updated neural networks 992, and/or the map information 994 may have resulted from new training and/or experiences represented in data received from any number of vehicles in the environment, and/or based on training performed at a datacenter (e.g., using the server(s) 978 and/or other servers).

The server(s) 978 may be used to train machine learning models (e.g., neural networks) based on training data. The training data may be generated by the vehicles, and/or may be generated in a simulation (e.g., using a game engine). In some examples, the training data is tagged (e.g., where the neural network benefits from supervised learning) and/or undergoes other pre-processing, while in other examples the training data is not tagged and/or pre-processed (e.g., where the neural network does not require supervised learning). Training may be executed according to any one or more classes of machine learning techniques, including, without limitation, classes such as: supervised training, semi-supervised training, unsupervised training, self-learning, reinforcement learning, federated learning, transfer learning, feature learning (including principal component and cluster analyses), multi-linear subspace learning, manifold learning, representation learning (including spare dictionary learning), rule-based machine learning, anomaly detection, and any variants or combinations therefor. Once the machine learning models are trained, the machine learning models may be used by the vehicles (e.g., transmitted to the vehicles over the network(s) 990, and/or the machine learning models may be used by the server(s) 978 to remotely monitor the vehicles.

In some examples, the server(s) 978 may receive data from the vehicles and apply the data to up-to-date real-time neural networks for real-time intelligent inferencing. The server(s) 978 may include deep-learning supercomputers and/or dedicated AI computers powered by GPU(s) 984, such as a DGX and DGX Station machines developed by NVIDIA. However, in some examples, the server(s) 978 may include deep learning infrastructure that use only CPU-powered datacenters.

The deep-learning infrastructure of the server(s) 978 may be capable of fast, real-time inferencing, and may use that capability to evaluate and verify the health of the processors, software, and/or associated hardware in the vehicle 900. For example, the deep-learning infrastructure may receive periodic updates from the vehicle 900, such as a sequence of images and/or objects that the vehicle 900 has located in that sequence of images (e.g., via computer vision and/or other machine learning object classification techniques). The deep-learning infrastructure may run its own neural network to identify the objects and compare them with the objects identified by the vehicle 900 and, if the results do not match and the infrastructure concludes that the AI in the vehicle 900 is malfunctioning, the server(s) 978 may transmit a signal to the vehicle 900 instructing a fail-safe computer of the vehicle 900 to assume control, notify the passengers, and complete a safe parking maneuver.

For inferencing, the server(s) 978 may include the GPU(s) 984 and one or more programmable inference accelerators (e.g., NVIDIA's TensorRT). The combination of GPU-powered servers and inference acceleration may make real-time responsiveness possible. In other examples, such as where performance is less critical, servers powered by CPUs, FPGAs, and other processors may be used for inferencing.

### EXAMPLE COMPUTING DEVICE

FIG. 10 is a block diagram of an example computing device(s) 1000 suitable for use in implementing some embodiments of the present disclosure. Computing device 1000 may include an interconnect system 1002 that directly or indirectly couples the following devices: memory 1004, one or more central processing units (CPUs) 1006, one or more graphics processing units (GPUs) 1008, a communication interface 1010, input/output (I/O) ports 1012, input/output components 1014, a power supply 1016, one or more presentation components 1018 (e.g., display(s)), and one or more logic units 1020. In at least one embodiment, the computing device(s) 1000 may comprise one or more virtual machines (VMs), and/or any of the components thereof may comprise virtual components (e.g., virtual hardware components). For non-limiting examples, one or more of the GPUs 1008 may comprise one or more vGPUs, one or more of the CPUs 1006 may comprise one or more vCPUs, and/or one or more of the logic units 1020 may comprise one or more virtual logic units. As such, a computing device(s) 1000 may include discrete components (e.g., a full GPU dedicated to the computing device 1000), virtual components (e.g., a portion of a GPU dedicated to the computing device 1000), or a combination thereof.

Although the various blocks of FIG. 10 are shown as connected via the interconnect system 1002 with lines, this is not intended to be limiting and is for clarity only. For example, in some embodiments, a presentation component 1018, such as a display device, may be considered an I/O component 1014 (e.g., if the display is a touch screen). As another example, the CPUs 1006 and/or GPUs 1008 may include memory (e.g., the memory 1004 may be representative of a storage device in addition to the memory of the GPUs 1008, the CPUs 1006, and/or other components). In other words, the computing device of FIG. 10 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 10.

The interconnect system 1002 may represent one or more links or busses, such as an address bus, a data bus, a control bus, or a combination thereof. The interconnect system 1002 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 1006 may be directly connected to the memory 1004. Further, the CPU 1006 may be directly connected to the GPU 1008. Where there is direct, or point-to-point connection between components, the interconnect system 1002 may include a PCIe link to carry out the connection. In these examples, a PCI bus need not be included in the computing device 1000.

The memory 1004 may include any of a variety of computer-readable media. The computer-readable media may be any available media that may be accessed by the computing device 1000. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 1004 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 1000. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 1006 may be configured to execute at least some of the computer-readable instructions to control one or more components of the computing device 1000 to perform one or more of the methods and/or processes described herein. The CPU(s) 1006 may each include one or more cores (e.g., one, two, four, eight, twenty-eight, seventy-two, etc.) that are capable of handling a multitude of software threads simultaneously. The CPU(s) 1006 may include any type of processor, and may include different types of processors depending on the type of computing device 1000 implemented (e.g., processors with fewer cores for mobile devices and processors with more cores for servers). For example, depending on the type of computing device 1000, the processor may be an Advanced RISC Machines (ARM) processor implemented using Reduced Instruction Set Computing (RISC) or an ×86 processor implemented using Complex Instruction Set Computing (CISC). The computing device 1000 may include one or more CPUs 1006 in addition to one or more microprocessors or supplementary co-processors, such as math co-processors.

In addition to or alternatively from the CPU(s) 1006, the GPU(s) 1008 may be configured to execute at least some of the computer-readable instructions to control one or more components of the computing device 1000 to perform one or more of the methods and/or processes described herein. One or more of the GPU(s) 1008 may be an integrated GPU (e.g., with one or more of the CPU(s) 1006 and/or one or more of the GPU(s) 1008 may be a discrete GPU. In embodiments, one or more of the GPU(s) 1008 may be a coprocessor of one or more of the CPU(s) 1006. The GPU(s) 1008 may be used by the computing device 1000 to render graphics (e.g., 3D graphics) or perform general purpose computations. For example, the GPU(s) 1008 may be used for General-Purpose computing on GPUs (GPGPU). The GPU(s) 1008 may include hundreds or thousands of cores that are capable of handling hundreds or thousands of software threads simultaneously. The GPU(s) 1008 may generate pixel data for output images in response to rendering commands (e.g., rendering commands from the CPU(s) 1006 received via a host interface). The GPU(s) 1008 may include graphics memory, such as display memory, for storing pixel data or any other suitable data, such as GPGPU data. The display memory may be included as part of the memory 1004. The GPU(s) 1008 may include two or more GPUs operating in parallel (e.g., via a link). The link may directly connect the GPUs (e.g., using NVLINK) or may connect the GPUs through a switch (e.g., using NVSwitch). When combined together, each GPU 1008 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 1006 and/or the GPU(s) 1008, the logic unit(s) 1020 may be configured to execute at least some of the computer-readable instructions to control one or more components of the computing device 1000 to perform one or more of the methods and/or processes described herein. In embodiments, the CPU(s) 1006, the GPU(s) 1008, and/or the logic unit(s) 1020 may discretely or jointly perform any combination of the methods, processes and/or portions thereof. One or more of the logic units 1020 may be part of and/or integrated in one or more of the CPU(s) 1006 and/or the GPU(s) 1008 and/or one or more of the logic units 1020 may be discrete components or otherwise external to the CPU(s) 1006 and/or the GPU(s) 1008. In embodiments, one or more of the logic units 1020 may be a coprocessor of one or more of the CPU(s) 1006 and/or one or more of the GPU(s) 1008.

Examples of the logic unit(s) 1020 include one or more processing cores and/or components thereof, such as Data Processing Units (DPUs), Tensor Cores (TCs), Tensor Processing Units(TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 1010 may include one or more receivers, transmitters, and/or transceivers that enable the computing device 1000 to communicate with other computing devices via an electronic communication network, included wired and/or wireless communications. The communication interface 1010 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 1020 and/or communication interface 1010 may include one or more data processing units (DPUs) to transmit data received over a network and/or through interconnect system 1002 directly to (e.g., a memory of) one or more GPU(s) 1008.

The I/O ports 1012 may enable the computing device 1000 to be logically coupled to other devices including the I/O components 1014, the presentation component(s) 1018, and/or other components, some of which may be built in to (e.g., integrated in) the computing device 1000. Illustrative I/O components 1014 include a microphone, mouse, keyboard, joystick, game pad, game controller, satellite dish, scanner, printer, wireless device, etc. The I/O components 1014 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 1000. The computing device 1000 may be include depth cameras, such as stereoscopic camera systems, infrared camera systems, RGB camera systems, touchscreen technology, and combinations of these, for gesture detection and recognition. Additionally, the computing device 1000 may include accelerometers or gyroscopes (e.g., as part of an inertia measurement unit (IMU)) that enable detection of motion. In some examples, the output of the accelerometers or gyroscopes may be used by the computing device 1000 to render immersive augmented reality or virtual reality.

The power supply 1016 may include a hard-wired power supply, a battery power supply, or a combination thereof. The power supply 1016 may provide power to the computing device 1000 to enable the components of the computing device 1000 to operate.

The presentation component(s) 1018 may include a display (e.g., a monitor, a touch screen, a television screen, a heads-up-display (HUD), other display types, or a combination thereof), speakers, and/or other presentation components. The presentation component(s) 1018 may receive data from other components (e.g., the GPU(s) 1008, the CPU(s) 1006, DPUs, etc.), and output the data (e.g., as an image, video, sound, etc.).

### EXAMPLE DATA CENTER

FIG. 11 illustrates an example data center 1100 that may be used in at least one embodiments of the present disclosure. The data center 1100 may include a data center infrastructure layer 1110, a framework layer 1120, a software layer 1130, and/or an application layer 1140.

As shown in FIG. 11, the data center infrastructure layer 1110 may include a resource orchestrator 1112, grouped computing resources 1114, and node computing resources (“node C.R.s”) 1116(1)-1116(N), where “N” represents any whole, positive integer. In at least one embodiment, node C.R.s 1116(1)-1116(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 1116(1)-1116(N) may correspond to a server having one or more of the above-mentioned computing resources. In addition, in some embodiments, the node C.R.s 1116(1)-1116(N) may include one or more virtual components, such as vGPUs, vCPUs, and/or the like, and/or one or more of the node C.R.s 1116(1)-1116(N) may correspond to a virtual machine (VM).

In at least one embodiment, grouped computing resources 1114 may include separate groupings of node C.R.s 1116 housed within one or more racks (not shown), or many racks housed in data centers at various geographical locations (also not shown). Separate groupings of node C.R.s 1116 within grouped computing resources 1114 may include grouped compute, network, memory or storage resources that may be configured or allocated to support one or more workloads. In at least one embodiment, several node C.R.s 1116 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 1112 may configure or otherwise control one or more node C.R.s 1116(1)-1116(N) and/or grouped computing resources 1114. In at least one embodiment, resource orchestrator 1112 may include a software design infrastructure (SDI) management entity for the data center 1100. The resource orchestrator 1112 may include hardware, software, or some combination thereof.

In at least one embodiment, as shown in FIG. 11, framework layer 1120 may include a job scheduler 1133, a configuration manager 1134, a resource manager 1136, and/or a distributed file system 1138. The framework layer 1120 may include a framework to support software 1132 of software layer 1130 and/or one or more application(s) 1142 of application layer 1140. The software 1132 or application(s) 1142 may respectively include web-based service software or applications, such as those provided by Amazon Web Services, Google Cloud and Microsoft Azure. The framework layer 1120 may be, but is not limited to, a type of free and open-source software web application framework such as Apache Spark™ (hereinafter “Spark”) that may utilize distributed file system 1138 for large-scale data processing (e.g., “big data”). In at least one embodiment, job scheduler 1133 may include a Spark driver to facilitate scheduling of workloads supported by various layers of data center 1100. The configuration manager 1134 may be capable of configuring different layers such as software layer 1130 and framework layer 1120 including Spark and distributed file system 1138 for supporting large-scale data processing. The resource manager 1136 may be capable of managing clustered or grouped computing resources mapped to or allocated for support of distributed file system 1138 and job scheduler 1133. In at least one embodiment, clustered or grouped computing resources may include grouped computing resource 1114 at data center infrastructure layer 1110. The resource manager 1136 may coordinate with resource orchestrator 1112 to manage these mapped or allocated computing resources.

In at least one embodiment, software 1132 included in software layer 1130 may include software used by at least portions of node C.R.s 1116(1)-1116(N), grouped computing resources 1114, and/or distributed file system 1138 of framework layer 1120. One or more types of software may include, but are not limited to, Internet web page search software, e-mail virus scan software, database software, and streaming video content software.

In at least one embodiment, application(s) 1142 included in application layer 1140 may include one or more types of applications used by at least portions of node C.R.s 1116(1)-1116(N), grouped computing resources 1114, and/or distributed file system 1138 of framework layer 1120. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 1134, resource manager 1136, and resource orchestrator 1112 may implement any number and type of self-modifying actions based on any amount and type of data acquired in any technically feasible fashion. Self-modifying actions may relieve a data center operator of data center 1100 from making possibly bad configuration decisions and possibly avoiding underutilized and/or poor performing portions of a data center.

The data center 1100 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 1100. In at least one embodiment, trained or deployed machine learning models corresponding to one or more neural networks may be used to infer or predict information using resources described above with respect to the data center 1100 by using weight parameters calculated through one or more training techniques, such as but not limited to those described herein.

In at least one embodiment, the data center 1100 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### EXAMPLE NETWORK ENVIRONMENTS

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 1000 of FIG. 10—e.g., each device may include similar components, features, and/or functionality of the computing device(s) 1000. In addition, where backend devices (e.g., servers, NAS, etc.) are implemented, the backend devices may be included as part of a data center 1100, an example of which is described in more detail herein with respect to FIG. 11.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 1000 described herein with respect to FIG. 10. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

### EXAMPLE PARAGRAPHS

A. A method comprising: obtaining, using one or more image sensors of a machine, image data representing one or more images depicting one or more objects; generating one or more updated images based at least on applying one or more spatial transformations to the image data to update one or more first spatial characteristics associated with the one or more objects to correspond to one or more second spatial characteristics associated with one or more reference objects; computing, based at least on comparing the one or more updated images with one or more reference images depicting the one or more reference objects, one or more metrics associated with the one or more images; determining, based at least on one or more values of the one or more metrics, that an image quality associated with at least one image of the one or more images is less than a threshold image quality; and updating one or more parameters associated with at least one image sensor of the one or more image sensors based at least on the image quality associated with the at least one image being less than the threshold image quality.

B. The method as recited in paragraph A, wherein the generating the one or more updated images by applying the one or more spatial transformations comprises: applying at least the one or more images and the one or more reference images to one or more machine learning models; obtaining, using the one or more machine learning models and based at least on the applying, one or more homography matrices associated with the one or more images and the one or more reference images; and transforming, using the one or more homography matrices, one or more coordinates associated with the one or more images to one or more coordinate systems associated with the one or more reference images.

C. The method as recited in any one of paragraphs A-B, wherein the applying of the one or more spatial transformations to the image data comprises at least warping the one or more images to modify at least one or more shapes, one or more orientations, one or more angles, or one or more geometries associated with the one or more objects depicted in the one or more images to correspond to the one or more reference objects.

D. The method as recited in any one of paragraphs A-C, wherein the one or more metrics associated with the one or more images include at least one of: one or more point spread function values; one or more modulation transfer function values; one or more noise equivalent quanta values; one or more edge spread function values; one or more Delta E values; one or more tone reproduction values; one or more contrast values; one or more color fidelity values; one or more lighting values; or one or more noise values.

E. The method as recited in any one of paragraphs A-D, further comprising: obtaining second image data representative of one or more second images captured using the at least one image sensor after the updating to the one or more parameters; using the second image data to compute one or more outputs; and causing the machine to perform one or more operations based at least on the one or more outputs.

F. The method as recited in any one of paragraphs A-E, wherein the one or more parameters associated with the image sensor include at least one or more image signal processor parameters corresponding to one or more image signal processors associated with the image sensor, the one or more image signal processor parameters including at least one of: one or more image sharpening parameters; one or more color correction matrix (CCM) parameters; one or more noise reduction parameters; one or more tone mapping parameters; one or more gamma parameters; or one or more white balance parameters.

G. A system comprising: one or more processors to: compare one or more images depicting one or more objects with one or more reference images depicting one or more reference objects that correspond to the one or more objects; determine, based at least on the comparison, that an image quality associated with at least one image of the one or more images is less than a threshold; and based at least on the determination that the image quality is less than the threshold, at least one of: update one or more parameters associated with a sensor used to generate the image; or perform one or more operations associated with a machine that includes the sensor.

H. The system as recited in paragraph G, the one or more processors further to modify one or more spatial characteristics associated with at least the one or more objects depicted in the one or more images, wherein the comparison of the one or more images with the one or more reference images is based at least on the modification of the one or more spatial characteristics.

I. The system as recited in any one of paragraphs G-H, the one or more processors further to modify one or more spatial characteristics associated with at least the one or more reference objects depicted in the one or more reference images, wherein the comparison of the one or more images with the one or more reference images is based at least on the modification of the one or more spatial characteristics.

J. The system as recited in any one of paragraphs G-I, wherein the one or more objects include one or more traffic signs associated with a driving surface in an environment, and the determination that the image quality associated with the image is less than a threshold is based at least on at least one of a sharpness, a contrast, a color, a saturation, or a brightness associated with a depiction of a traffic sign in the image.

K. The system as recited in any one of paragraphs G-J, the one or more processors further to: determine one or more homography matrices associated with the one or more images and the one or more reference images; and update one or more coordinates associated with at least one of the one or more images or the one or more reference images using the one or more homography matrices, wherein the comparison of the one or more images with the one or more reference images is based at least on the update of the one or more coordinates.

L. The system as recited in any one of paragraphs G-K, wherein the determination of the one or more homography matrices is based at least on applying the one or more images and the one or more reference images to one or more machine learning models.

M. The system as recited in any one of paragraphs G-L, the one or more processors further to compute, based at least on the comparison, one or more metrics associated with one or more differences between the one or more images and the one or more reference images, wherein the determination that the image quality is less than the threshold is based at least on evaluating the one or more metrics.

N. The system as recited in any one of paragraphs G-M, wherein the one or more metrics associated with the one or more images include at least one of: one or more point spread function values; one or more modulation transfer function values; one or more noise equivalent quanta values; one or more edge spread function values; one or more Delta E values; one or more tone reproduction values; one or more contrast values; one or more color fidelity values; one or more lighting values; or one or more noise values.

O. The system as recited in any one of paragraphs G-N, the one or more processors further to associate, based at least on the determination that the image quality is less than the threshold, a confidence score associated with image data generated using the sensor, wherein the one or more operations associated with the machine are determined to be performed based at least on the confidence score associated with the image data.

P. The system as recited in any one of paragraphs G-O, wherein: the one or more parameters associated with the sensor used to generate the image include one or more image signal processor parameters corresponding to one or more image signal processors associated with the sensor, and the update of the one or more parameters reduces one or more differences between the one or more reference images and one or more second images depicting the one or more objects.

Q. The system as recited in any one of paragraphs G-P, wherein the system is comprised in at least one of: a control system for an autonomous or semi-autonomous machine; a perception system for an autonomous or semi-autonomous machine; a system for performing one or more simulation operations; a system for performing one or more digital twin operations; a system for performing light transport simulation; a system for performing collaborative content creation for 3D assets; a system for performing one or more deep learning operations; a system implemented using an edge device; a system implemented using a robot; a system for performing one or more generative AI operations; a system for performing operations using a large language model; a system for performing operations using one or more vision language models (VLMs); a system for performing operations using one or more multi-modal language models; a system implementing one or more machine learning models as an inference microservice using one or more operating system (OS)-level virtualization packages; a system for performing one or more conversational AI operations; a system for generating synthetic data; a system for presenting at least one of virtual reality content, augmented reality content, or mixed reality content; a system incorporating one or more virtual machines (VMs); a system implemented at least partially in a data center; or a system implemented at least partially using cloud computing resources.

R. At least one processor comprising: processing circuitry to cause performance of one or more operations associated with an ego-machine based at least on an output computed using a first image obtained using an image sensor having one or more updated parameters, the one or more updated parameters determined based at least on computing one or more values of one or more metrics indicating at least an image quality associated with a second image obtained using the image sensor prior to updating the one or more parameters, the one or more values computed based at least on comparing an object depicted in the second image with a synthetically generated image depicting at least one of the object or a reference object corresponding to the object.

S. The processor as recited in paragraph R, the processing circuitry further to modify at least one of the second image or the synthetically generated image to transform one or more spatial characteristics associated with a depiction of at least one of the object or the reference object, wherein the comparing is based at least on the modification of the at least one of the second image or the synthetically generated image.

T. The processor as recited in any one of paragraphs R-S, wherein the processor is comprised in at least one of: a control system for an autonomous or semi-autonomous machine; a perception system for an autonomous or semi-autonomous machine; a system for performing one or more simulation operations; a system for performing one or more digital twin operations; a system for performing light transport simulation; a system for performing collaborative content creation for 3D assets; a system for performing one or more deep learning operations; a system implemented using an edge device; a system implemented using a robot; a system for performing one or more generative AI operations; a system for performing operations using a large language model; a system for performing operations using one or more vision language models (VLMs); a system for performing operations using one or more multi-modal language models; a system implementing one or more machine learning models as an inference microservice using one or more operating system (OS)-level virtualization packages; a system for performing one or more conversational AI operations; a system for generating synthetic data; a system for presenting at least one of virtual reality content, augmented reality content, or mixed reality content; a system incorporating one or more virtual machines (VMs); a system implemented at least partially in a data center; or a system implemented at least partially using cloud computing resources.

What is claimed is:

1. A method comprising:
obtaining, using one or more image sensors of a machine, image data representing one or more images depicting one or more objects;
generating one or more updated images based at least on applying one or more spatial transformations to the image data to update one or more first spatial characteristics associated with the one or more objects to correspond to one or more second spatial characteristics associated with one or more reference objects;
computing, based at least on comparing the one or more updated images with one or more reference images depicting the one or more reference objects, one or more metrics associated with the one or more images;
determining, based at least on one or more values of the one or more metrics, that an image quality associated with at least one image of the one or more images is less than a threshold image quality; and
updating one or more parameters associated with at least one image sensor of the one or more image sensors based at least on the image quality associated with the at least one image being less than the threshold image quality.

2. The method of claim 1, wherein the generating the one or more updated images by applying the one or more spatial transformations comprises:
applying at least the one or more images and the one or more reference images to one or more machine learning models;
obtaining, using the one or more machine learning models and based at least on the applying, one or more homography matrices associated with the one or more images and the one or more reference images; and
transforming, using the one or more homography matrices, one or more coordinates associated with the one or more images to one or more coordinate systems associated with the one or more reference images.

3. The method of claim 1, wherein the applying of the one or more spatial transformations to the image data comprises at least warping the one or more images to modify at least one or more shapes, one or more orientations, one or more angles, or one or more geometries associated with the one or more objects depicted in the one or more images to correspond to the one or more reference objects.

4. The method of claim 1, wherein the one or more metrics associated with the one or more images include at least one of:
one or more point spread function values;
one or more modulation transfer function values;
one or more noise equivalent quanta values;
one or more edge spread function values;
one or more Delta E values;
one or more tone reproduction values;
one or more contrast values;
one or more color fidelity values;
one or more lighting values; or
one or more noise values.

5. The method of claim 1, further comprising:
obtaining second image data representative of one or more second images captured using the at least one image sensor after the updating to the one or more parameters;
using the second image data to compute one or more outputs; and
causing the machine to perform one or more operations based at least on the one or more outputs.

6. The method of claim 1, wherein the one or more parameters associated with the image sensor include at least one or more image signal processor parameters corresponding to one or more image signal processors associated with the image sensor, the one or more image signal processor parameters including at least one of:
one or more image sharpening parameters;
one or more color correction matrix (CCM) parameters;
one or more noise reduction parameters;
one or more tone mapping parameters;
one or more gamma parameters; or
one or more white balance parameters.

7. A system comprising:
one or more processors to:
compare one or more images depicting one or more objects with one or more reference images depicting one or more reference objects that correspond to the one or more objects;
determine, based at least on the comparison, that an image quality associated with at least one image of the one or more images is less than a threshold; and
based at least on the determination that the image quality is less than the threshold, at least one of:
update one or more parameters associated with a sensor used to generate the image; or
perform one or more operations associated with a machine that includes the sensor.

8. The system of claim 7, the one or more processors further to modify one or more spatial characteristics associated with at least the one or more objects depicted in the one or more images, wherein the comparison of the one or more images with the one or more reference images is based at least on the modification of the one or more spatial characteristics.

9. The system of claim 7, the one or more processors further to modify one or more spatial characteristics associated with at least the one or more reference objects depicted in the one or more reference images, wherein the comparison of the one or more images with the one or more reference images is based at least on the modification of the one or more spatial characteristics.

10. The system of claim 7, wherein the one or more objects include one or more traffic signs associated with a driving surface in an environment, and the determination that the image quality associated with the image is less than a threshold is based at least on at least one of a sharpness, a contrast, a color, a saturation, or a brightness associated with a depiction of a traffic sign in the image.

11. The system of claim 7, the one or more processors further to:
determine one or more homography matrices associated with the one or more images and the one or more reference images; and
update one or more coordinates associated with at least one of the one or more images or the one or more reference images using the one or more homography matrices,
wherein the comparison of the one or more images with the one or more reference images is based at least on the update of the one or more coordinates.

12. The system of claim 11, wherein the determination of the one or more homography matrices is based at least on applying the one or more images and the one or more reference images to one or more machine learning models.

13. The system of claim 7, the one or more processors further to compute, based at least on the comparison, one or more metrics associated with one or more differences between the one or more images and the one or more reference images, wherein the determination that the image quality is less than the threshold is based at least on evaluating the one or more metrics.

14. The system of claim 13, wherein the one or more metrics associated with the one or more images include at least one of:
one or more point spread function values;
one or more modulation transfer function values;
one or more noise equivalent quanta values;
one or more edge spread function values;
one or more Delta E values;
one or more tone reproduction values;
one or more contrast values;
one or more color fidelity values;
one or more lighting values; or
one or more noise values.

15. The system of claim 7, the one or more processors further to associate, based at least on the determination that the image quality is less than the threshold, a confidence score associated with image data generated using the sensor, wherein the one or more operations associated with the machine are determined to be performed based at least on the confidence score associated with the image data.

16. The system of claim 7, wherein:
the one or more parameters associated with the sensor used to generate the image include one or more image signal processor parameters corresponding to one or more image signal processors associated with the sensor, and
the update of the one or more parameters reduces one or more differences between the one or more reference images and one or more second images depicting the one or more objects.

17. The system of claim 7, wherein the system is comprised in at least one of:
a control system for an autonomous or semi-autonomous machine;
a perception system for an autonomous or semi-autonomous machine;
a system for performing one or more simulation operations;
a system for performing one or more digital twin operations;
a system for performing light transport simulation;
a system for performing collaborative content creation for 3D assets;
a system for performing one or more deep learning operations;
a system implemented using an edge device;
a system implemented using a robot;
a system for performing one or more generative AI operations;
a system for performing operations using a large language model;
a system for performing operations using one or more vision language models (VLMs);
a system for performing operations using one or more multi-modal language models;
a system implementing one or more machine learning models as an inference microservice using one or more operating system (OS)-level virtualization packages;
a system for performing one or more conversational AI operations;
a system for generating synthetic data;
a system for presenting at least one of virtual reality content, augmented reality content, or mixed reality content;
a system incorporating one or more virtual machines (VMs);
a system implemented at least partially in a data center; or
a system implemented at least partially using cloud computing resources.

18. At least one processor comprising:
processing circuitry to cause performance of one or more operations associated with an ego-machine based at least on an output computed using a first image obtained using an image sensor having one or more updated parameters, the one or more updated parameters determined based at least on computing one or more values of one or more metrics indicating at least an image quality associated with a second image obtained using the image sensor prior to updating the one or more parameters, the one or more values computed based at least on comparing an object depicted in the second image with a synthetically generated image depicting at least one of the object or a reference object corresponding to the object.

19. The processor of claim 18, the processing circuitry further to modify at least one of the second image or the synthetically generated image to transform one or more spatial characteristics associated with a depiction of at least one of the object or the reference object, wherein the comparing is based at least on the modification of the at least one of the second image or the synthetically generated image.

20. The processor of claim 18, wherein the processor is comprised in at least one of:
a control system for an autonomous or semi-autonomous machine;
a perception system for an autonomous or semi-autonomous machine;
a system for performing one or more simulation operations;
a system for performing one or more digital twin operations;
a system for performing light transport simulation;
a system for performing collaborative content creation for 3D assets;
a system for performing one or more deep learning operations;
a system implemented using an edge device;
a system implemented using a robot;
a system for performing one or more generative AI operations;
a system for performing operations using a large language model;
a system for performing operations using one or more vision language models (VLMs);
a system for performing operations using one or more multi-modal language models;
a system implementing one or more machine learning models as an inference microservice using one or more operating system (OS)-level virtualization packages;
a system for performing one or more conversational AI operations;
a system for generating synthetic data;
a system for presenting at least one of virtual reality content, augmented reality content, or mixed reality content;
a system incorporating one or more virtual machines (VMs);
a system implemented at least partially in a data center; or
a system implemented at least partially using cloud computing resources.
